(19) United States
(12) Patent Application Publication
(10) Pub. No.: US 2026/0130344 A1
(43) Pub. Date: May 14, 2026

(54) FEEDBACK DEVICE, FEEDBACK SYSTEM, AND FEEDBACK METHOD

(71) Applicant: SEIKO EPSON CORPORATION, TOKYO (JP)

(72) Inventors: Takumi SHIMOMUKAI, MATSUMOTO-SHI (JP); Ryoki WATANABE, MATSUMOTO-SHI (JP); Hikaru KURASAWA, MATSUMOTO-SHI (JP); Kenji MATSUZAKA, SHIOJIRI-SHI (JP)

(21) Appl. No.: 19/385,225

(22) Filed: Nov. 11, 2025

(30) Foreign Application Priority Data
Nov. 11, 2024 (JP) 2024-196438

(51) Int. Cl. A01K 29/00

(52) U.S. Cl. CPC A01K 29/002; A01K 2227/101

(57) ABSTRACT

A feedback device includes an acquisition unit configured to acquire a BCS evaluation value obtained by evaluating a BCS value representing a body condition score of livestock with a reference value for evaluating the BCS value and a feedback unit configured to output feedback information concerning the livestock based on the acquired BCS evaluation value.

The present application is based on, and claims priority from JP Application Serial Number 2024-196438, filed November 11, 2024, the disclosure of which is hereby incorporated by reference herein in its entirety.

### BACKGROUND

### 1. Technical Field

The present disclosure relates to a feedback device, a feedback system, a feedback method, and a non-transitory computer readable storage medium storing a program.

### 2. Related Art

JP-A-2007-175050 discloses a management system that automatically estimates the weight of an animal individual based on image information of the animal individual acquired by imaging means and the distance to the animal individual and compares the estimated weight with an evaluation reference weight to guide and distribute the animal individual to a predetermined feeding area.

JP-A-2007-175050 is an example of the related art.

In a breeding system for breeding livestock such as cattle, by executing feedback based on the weight of the livestock as disclosed in JP-A-2007-175050, more appropriate livestock management reflecting a fatness and thinness degree of the livestock can be executed. Here, a body condition score (BCS) is known as a useful indicator for evaluating the fatness and thinness degree of livestock. There is a demand for a technique for executing appropriate feedback for livestock making use of the BCS.

### SUMMARY

According to a first aspect of the present disclosure, a feedback device is provided. The feedback device includes: an acquisition unit configured to acquire a BCS evaluation value obtained by evaluating a BCS value representing a body condition score of livestock with a reference value for evaluating the BCS value; and a feedback unit configured to output feedback information concerning the livestock based on the acquired BCS evaluation value.

According to a second aspect of the present disclosure, a feedback system is provided. The feedback system includes: a BCS acquisition unit configured to acquire a BCS value representing a body condition score of livestock; a reference value acquisition unit configured to acquire a reference value for evaluating the BCS value; an evaluation value acquisition unit configured to acquire a BCS evaluation value obtained by evaluating the BCS value with the reference value; and a feedback unit configured to output feedback information concerning the livestock based on the acquired BCS evaluation value.

According to a third aspect of the present disclosure, a feedback method is provided. The feedback method includes: acquiring a BCS evaluation value obtained by evaluating a BCS value representing a body condition score of livestock with a reference value for evaluating the BCS value; and outputting feedback information concerning the livestock based on the acquired BCS evaluation value.

According to a fourth aspect of the present disclosure, a non-transitory computer-readable storage medium storing a program is provided. The program causes a computer to implement: a function of acquiring a BCS evaluation value obtained by evaluating a BCS value representing a body condition score of livestock with a reference value for evaluating the BCS value; and a function of outputting feedback information concerning the livestock based on the acquired BCS evaluation value.

### BRIEF DESCRIPTION OF THE DRAWINGS

FIG. 1 is a diagram illustrating a schematic configuration of a breeding system in a first embodiment.

FIG. 2 is a block diagram of a feedback system in the first embodiment.

FIG. 3 is a flowchart of feedback processing in the first embodiment.

FIG. 4 is a flowchart of feedback processing in a second embodiment.

FIG. 5 is a flowchart of evaluation value acquisition processing in the second embodiment.

FIG. 6 is a diagram illustrating evaluation criteria for a BCS value in the second embodiment.

FIG. 7 is a flowchart of feedback processing in a third embodiment.

FIG. 8 is a diagram illustrating an example of correlation data in the third embodiment.

FIG. 9 is a block diagram of a feedback system in a fourth embodiment.

FIG. 10 is a flowchart of feedback processing in the fourth embodiment.

FIG. 11 is a diagram illustrating an example of correlation data in the fourth embodiment.

FIG. 12 is a diagram illustrating correlation data in a fifth embodiment.

FIG. 13 is a diagram illustrating a first example of display information in a sixth embodiment.

FIG. 14 is a diagram illustrating a second example of the display information in the sixth embodiment.

FIG. 15 is a diagram illustrating a third example of the display information in the sixth embodiment.

FIG. 16 is a diagram illustrating a fourth example of the display information in the sixth embodiment.

FIG. 17 is a diagram illustrating a fifth example of the display information in the sixth embodiment.

FIG. 18 is a diagram illustrating a sixth example of the display information in the sixth embodiment.

FIG. 19 is a diagram illustrating a seventh example of the display information in the sixth embodiment.

FIG. 20 is a diagram illustrating an eighth example of the display information in the sixth embodiment.

### DESCRIPTION OF EMBODIMENTS

### A. First Embodiment:

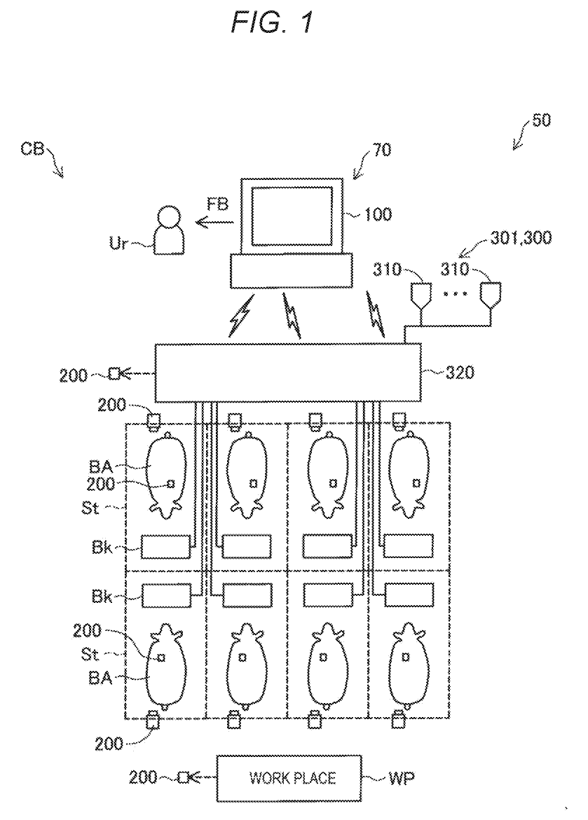

FIG. 1 is a diagram illustrating a schematic configuration of a breeding system 50 in the first embodiment. The breeding system 50 is configured as a system for breeding cows BA that are livestock. In the present embodiment, the cows BA are dairy cows. In another embodiment, the cows BA may be, for example, beef cows. In another embodiment, the livestock may not be the cows BA and may be any livestock such as pigs or goats. In the present embodiment, a plurality of livestock individuals are bred in the breeding system 50. Hereinafter, the livestock individual is also simply referred to as "livestock".

In the present embodiment, the breeding system 50 is used in a cattle shed CB. The cattle shed CB includes a plurality of stalls St for accommodating the cows BA and one or more work places WP. In the present embodiment, one cow BA is allocated to one stall St. Feeding tubs Bk for storing feed are installed in the stalls St. The feed in the feeding tubs Bk is eaten by the cows BA. The work places WP are places for executing various kinds of work concerning breeding of the cows BA. The work places WP in the present embodiment include, for example, a measurement place for executing measurement of the cow BA, a treatment place for treating excrement of the cows BA, a milking place for executing milking of the cows BA, and a preparation place for preparing the feed. For example, at least some of the stalls St may be used as the work places.

The breeding system 50 includes a feedback system 70 including a feedback device 100 and one or more breeding devices 300. Furthermore, the breeding system 50 in the present embodiment includes one or more sensors 200.

The breeding devices 300 are devices used for breeding livestock. In FIG. 1, feeding machines 301 that execute feeding to the cows BA are illustrated as an example of the breeding devices 300. The feeding machine 301 includes a plurality of input units 310 for putting in raw materials of the feed and a blending unit 320 for blending the input raw materials. The input unit 310 includes, for example, a hopper. The blending unit 320 includes, for example, a mixer that mixes and blends the raw materials. The feeding machine 301 prepares the feed by mixing the raw materials input to the input unit 310 with the blending unit 320 and delivers the prepared feed to the feeding tub Bk. The raw material may be a prepared feed or may be, for example, commercially available feed. In another embodiment, the feeding machine 301 may be configured to execute, for example, only one of preparation of feed and provision of the feed to the cows BA. The feeding machine 301 may be configured as, for example, a feeding robot. The feeding robot executes, for example, preparation and provision of feed.

The sensors 200 are sensors for monitoring the cows BA. The sensors 200 are an example of the breeding devices 300. The sensors 200 include, for example, sensors for acquiring states of the cows BA and sensors for acquiring a breeding environment of the cows BA. The sensors 200 include, for example, cameras, weight scales, operation sensors, microphones, temperature sensors, humidity sensors, photoelectric sensors, spectroscopes, illuminometers, anemometers, and anemoscopes. For example, the sensors 200 may be installed at places of the cattle shed CB or may be attached to the cows BA. For example, the cameras are installed in the stalls St, the breeding devices 300, the vicinity of the breeding devices 300, or the work places WP. The cameras image, for example, the cows BA, feed, milk of the cows BA, and excrement of the cows BA. The cameras may be, for example, stereo cameras. The weight scales are installed in, for example, the work places WP and measure the weight of the cows BA, the weight of milk, and the weight of excrement. The operation sensors include, for example, acceleration sensors and angular velocity sensors. The operation sensors are attached to, for example, the cows BA. The temperature sensors include, for example, thermometers for measuring the body temperature of the cows BA and thermometers for measuring the ambient temperature of the cattle shed CB. The temperature sensors may include, for example, infrared cameras. The temperature sensors are installed in, for example, the cows BA and respective places of the cattle shed CB. The photoelectric sensors include, for example, infrared sensors that detect the presence or absence of objects by transmitting and receiving infrared rays. The spectroscopes are used to analyze various objects such as feed, milk, and excrement by using optical spectra. The spectroscopes may be configured as, for example, spectroscopic cameras.

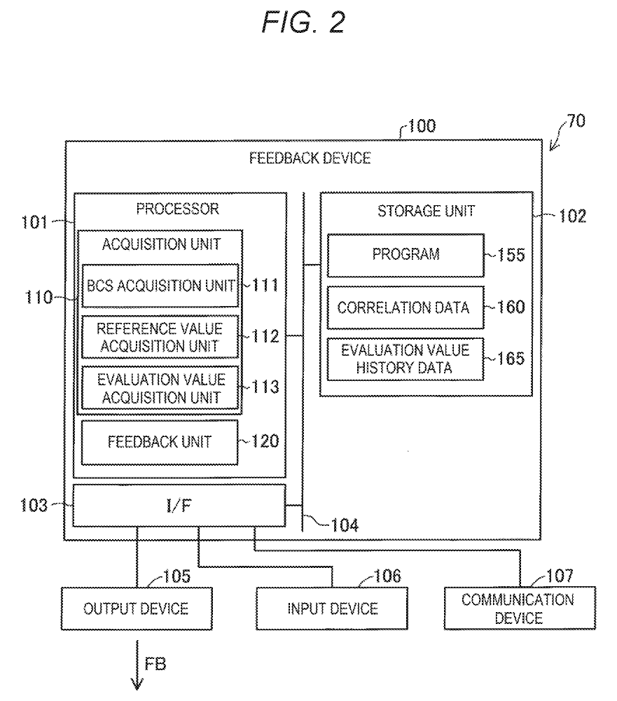

FIG. 2 is a block diagram illustrating a schematic configuration of the feedback system 70 in the first embodiment. The feedback device 100 in the present embodiment includes a computer including one or more processors 101, a storage unit 102 including a ROM and a RAM, an input and output interface 103, and an internal bus 104. The processors 101, the storage unit 102, and the input and output interface 103 are bidirectionally communicably connected via the internal bus 104. An output device 105, an input device 106, and a communication device 107 are coupled to the input and output interface 103. The storage unit 102 in the present embodiment stores a program 155, correlation data 160, and evaluation value history data 165. The processor 101 executes the program 155 stored in the storage unit 102 to implement various functions including functions serving as the acquisition unit 110 and the feedback unit 120.

The input device 106 includes, for example, a mouse and a keyboard. The feedback device 100 receives various kinds of input from a user Ur via the input device 106.

The output device 105 is configured as a display device capable of outputting visual information, a speaker capable of outputting audio information, or a printing device capable of outputting information through printing on a medium. The display device includes, for example, a liquid crystal panel or an organic EL panel. The output device 105 serving as the display device may be configured as, for example, a touch panel capable of receiving touch operation from the user Ur. In this case, the output device 105 may also function as, for example, the input device 106.

The communication device 107 is a device for communicating with a device on the outside of the feedback device 100 by wireless communication or wired communication. The communication device 107 in the present embodiment is configured to be capable of communicating with the sensors 200 and the breeding device 300. The output device 105 and the communication device 107 may be configured to be capable of outputting, for example, various information stored in the storage unit 102 in response to a request from the user Ur.

The acquisition unit 110 acquires various information used in the feedback system 70. The acquisition unit 110 includes a BCS evaluation value acquisition unit 113. In the present embodiment, the acquisition unit 110 further includes a BCS acquisition unit 111 and a reference value acquisition unit 112.

The BCS acquisition unit 111 acquires a BCS value representing a body condition score (BCS) of livestock. In the present embodiment, the BCS acquisition unit 111 is configured to be capable of acquiring a BCS value for each of livestock individuals bred in the breeding system 50. In the present embodiment, the BCS acquisition unit 111 acquires a BCS value using a detection result by the sensor 200. In this case, the BCS acquisition unit 111 acquires the BCS value using, for example, a captured image of livestock captured by a camera serving as the sensor 200 and an estimation model for estimating the BCS value. The estimation model for estimating the BCS value is, for example, a machine learning model trained to receive the captured image as input and output a BCS. In another embodiment, the BCS acquisition unit 111 may acquire a BCS value determined by a person. In this case, the determined BCS value is, for example, input to the feedback device 100 via the input device 106.

As the machine learning model, for example, a neural network, a support vector machine (SVM), a decision tree, a random forest, a linear regression analysis, linear discrimination, reinforcement learning, or a probability model can be used. The machine learning model may be a deep learning model such as a convolutional neural network (CNN). The machine learning model may be learned using various learning algorithms such as supervised learning, unsupervised learning, and reinforcement learning.

As the BCS, a general BCS defined as a numerical value in increments of 0.25 from 2.0 to 5.0 may be used or a BCS defined in another mode may be used. For example, in a form in which a BCS value is acquired using an estimation model as in the present embodiment, it is possible to easily implement expanding a numerical range of the BCS more than the above and further reducing an increase or decrease range of the BCS.

The reference value acquisition unit 112 acquires a reference value for evaluating a BCS value. For example, the reference value acquisition unit 112 may acquire a reference value stored in advance in the storage unit 102 or may acquire a reference value input by the user Ur via the input device 106.

As the reference value, for example, a different value may be used according to an age, a lactation period, or the number of times of birth of livestock or a constant value may be used regardless of the age, the lactation period, or the number of times of birth. In the present embodiment, a reference value corresponding to the lactation period of a cow, which is livestock, is used as the reference value. The lactation period is equivalent to a period obtained by dividing a lactation cycle of a cow into a plurality of periods. For example, the lactation period may be represented by a period representing the lactation cycle of the cow, may be represented by an elapsed time from the immediately preceding delivery timing, or may be represented by a remaining time until the next delivery timing. The elapsed time is represented by, for example, the number of elapsed days or the number of elapsed months. The next delivery timing is estimated based on, for example, timing when artificial insemination of the livestock is successful. The lactation cycle includes an early lactation period, a middle lactation period, a late lactation period, and a dry lactation period. The storage unit 102 may store reference value data that defines reference values corresponding to the lactation periods described above. In this way, the reference value acquisition unit 112 can acquire a reference value corresponding to a lactation period of livestock by specifying a lactation period of the livestock using, for example, identification information of the livestock and referring to the reference value data based on the specified lactation period.

The BCS evaluation value acquisition unit 113 acquires a BCS evaluation value obtained by evaluating the BCS value with a reference value. In the present embodiment, the BCS evaluation value acquisition unit 113 is configured to be capable of acquiring a BCS evaluation value for each of the livestock individuals bred in the breeding system 50. In the present embodiment, the BCS evaluation value acquisition unit 113 is capable of acquiring the BCS evaluation value by evaluating a BCS value acquired by the BCS acquisition unit 111 with the reference value acquired by the reference value acquisition unit 112 and determining the BCS evaluation value anew. In this case, the BCS evaluation value acquisition unit 113 evaluates the BCS value by comparing a magnitude relationship between the BCS value and the reference value and acquires the BCS evaluation value. The BCS evaluation value acquisition unit 113 is capable of acquiring a BCS evaluation value included in the evaluation value history data 165 stored in the storage unit 102. The evaluation value history data 165 includes one or more BCS evaluation values acquired in the past. In the present embodiment, when a BCS evaluation value is determined anew, the BCS evaluation value acquisition unit 113 adds the BCS evaluation value to the evaluation value history data 165 by causing the storage unit 102 to store the BCS evaluation value. In another embodiment, the BCS evaluation value acquisition unit 113 may acquire a BCS evaluation value from, for example, a database provided on the outside of the breeding system 50 or may acquire a BCS evaluation value input by the user Ur via the input device 106.

In the present embodiment, the BCS evaluation value includes evaluation values EV1 to EV6. The evaluation value EV1 represents "dangerously excessively fat". The evaluation value EV2 represents an evaluation value equivalent to "nearly dangerously slightly fat". The evaluation value EV3 represents "slightly fat close to a standard". The evaluation value EV4 represents "slightly thin close to a standard". The evaluation value EV5 represents "nearly dangerously slightly thin". The evaluation value EV6 represents "dangerously excessively thin". The evaluation values EV1 to EV3 are acquired when the BCS value is larger than the reference value. Values of the evaluation values EV3, EV2, and EV1 increase in this order. The evaluation values EV4 to EV6 are acquired when the BCS value is less than the reference value. Values of the evaluation values EV4, EV5, and EV6 decrease in this order. In the present embodiment, the evaluation value EV3 is acquired even when the BCS value and the reference value are equal. In another embodiment, when the BCS value and the reference value are equal, for example, the evaluation value EV4 may be acquired or the evaluation value EV0 corresponding to the BCS value and the reference value being equal may be acquired. In this case, the evaluation value EV0 is a BCS evaluation value lower than the evaluation value EV3 and higher than the evaluation value EV4.

Hereinafter, BCS evaluation values for BCS values larger than a standard value, such as the evaluation values EV1 to EV3, are also referred to as "high" BCS evaluation values. BCS evaluation values for BCS values smaller than the standard value, such as the evaluation values EV4 to EV6, are also referred to as "low" BCS evaluation values.

The feedback unit 120 outputs feedback information concerning the livestock based on at least one BCS evaluation value acquired by the BCS evaluation value acquisition unit 113. More specifically, the feedback unit 120 executes feedback concerning the livestock to at least one of the user Ur and the breeding device 300 illustrated in FIG. 1. Hereinafter, feedback concerning the livestock is referred to as livestock feedback FB as well. When executing the livestock feedback FB, the feedback unit 120 generates feedback information and outputs the generated feedback information. The feedback information is information for the livestock feedback FB.

In the present embodiment, the feedback unit 120 executes the livestock feedback FB on the user Ur by outputting the feedback information to the output device 105 serving as the display device and causing a display screen of the display device to display display information based on the feedback information. For example, the feedback information may be information representing a BCS evaluation value, may be notification information based on the BCS evaluation value, or may be a signal to the various breeding devices 300 based on the BCS evaluation value. The notification information based on the BCS evaluation value may be, for example, information clearly indicating whether the BCS value is proper or abnormal, or information suggesting treatment that is preferably performed by the user Ur according to the BCS evaluation value.

In the present embodiment, the feedback unit 120 generates feedback information by referring to the correlation data 160 based on the BCS evaluation value acquired by the BCS evaluation value acquisition unit 113 and outputs the generated feedback information. The correlation data 160 is data in which BCS evaluation values and feedback information are correlated in advance. More specifically, the correlation data 160 includes BCS evaluation values and various information such as messages and signals serving as feedback information correlated with the BCS evaluation values. For example, in the correlation data 160, a message representing "dangerously excessively fat" or a message and a signal for coping with "dangerously excessively fat" are correlated with the evaluation value EV1. A method of coping with "dangerously excessively fat" is, for example, reducing a feeding amount to livestock. For example, in the correlation data 160, a message representing "dangerously excessively thin" or a message and a signal for coping with "dangerously excessively thin" are correlated with the evaluation value EV6. A method of coping with "dangerously excessively thin" is, for example, increasing a feeding amount to livestock. The correlation data 160 explained above is expressed in, for example, a table data format.

The feedback information may be output, for example, for each livestock individual. The feedback information may be output, for example, for each group of a plurality of livestock individuals. In this case, the BCS value or the BCS evaluation value acquired by the acquisition unit 110 may be a representative value or a statistical value for the plurality of livestock individuals. Examples of the statistical value include an average value, a median value, a maximum value, a minimum value, and a mode value.

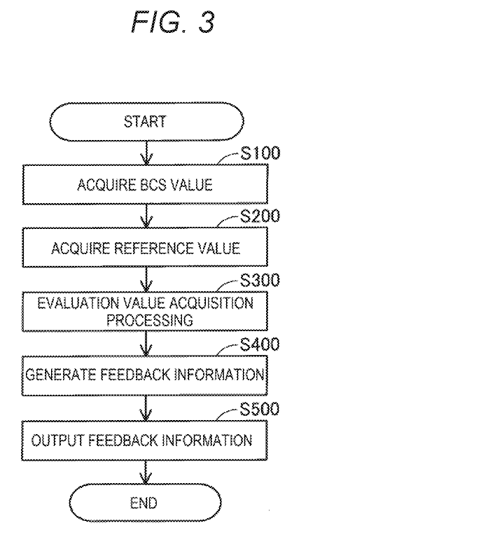

FIG. 3 is a flowchart of feedback processing for implementing a feedback method in the present embodiment. The feedback processing is executed by the processor 101. For example, the feedback processing may be started at predetermined time intervals or may be started when predetermined operation is performed by the user Ur via the input device 106.

In step S100 in FIG. 3, the BCS acquisition unit 111 acquires a BCS value of livestock. In step S200, the reference value acquisition unit 112 acquires a reference value for evaluating the BCS value acquired in step S100. In step S300, the BCS evaluation value acquisition unit 113 executes evaluation value acquisition processing for acquiring a BCS evaluation value. In the evaluation value acquisition processing in the present embodiment, the BCS evaluation value acquisition unit 113 acquires the BCS evaluation value by evaluating the BCS value acquired in step S100 with the reference value acquired in step S200.

In step S400, the feedback unit 120 generates feedback information based on the BCS evaluation value acquired in step S300. In step S500, the feedback unit 120 outputs the feedback information generated in step S400.

With the feedback device 100 in the present embodiment explained above, the feedback information concerning the livestock is output based on the BCS evaluation value obtained by evaluating the BCS value of the livestock with the reference value. For that reason, for example, as compared with a form in which feedback information is output simply based on the weight of livestock, it is possible to output feedback information that more effectively reflects a fatness and thinness degree of the livestock. Further, it is possible to reduce the complexity of the processing compared with a form in which feedback information is output based on a simple BCS value. In particular, when the livestock feedback FB is executed on the user Ur, it is possible to easily provide clearer feedback information that reduces determination cost of the user Ur while reducing the complexity of the processing. As explained above, according to the present embodiment, it is possible to execute appropriate livestock feedback FB by using the BCS of livestock.

An appropriate BCS value of the livestock can transition according to a life cycle of the livestock, such as an age, a lactation period, and the number of times of birth. Here, in the present embodiment, as the reference value for evaluating the BCS value, not a constant value but a different value corresponding to the life cycle of the livestock, such as the age, the lactation period, and the number of times of birth of the livestock, can be used. For that reason, it is possible to execute appropriate livestock feedback FB corresponding to the life cycle of the livestock compared with a form in which feedback information is output based on a simple BCS value. Evaluation feeling concerning the magnitude of the BCS value, that is, feeling of evaluation of fatness and thinness based on the BCS value can fluctuate from person to person. For that reason, for example, in a form in which information representing a simple BCS value is presented to the user Ur as feedback information, it is likely that fatness and thinness evaluation based on the presented feedback information is different depending on the user Ur and content of the subsequent treatment determined based on the fatness and thinness evaluation can fluctuate more. On the other hand, in the present embodiment, by presenting the information representing the BCS evaluation value obtained by evaluating the BCS value with the reference value to the user Ur as the feedback information, it is possible to prevent the fatness and thinness evaluation based on the feedback information from fluctuating depending on the user Ur. As a result, it is also possible to prevent the content of the subsequent treatment from fluctuating because of a difference in fatness and thinness evaluation.

In the present embodiment, the feedback information is output by the correlation data 160 stored in advance in the storage unit 102 being referred to based on the BCS evaluation value. In this way, the livestock feedback FB can be executed by a simpler method. In the present embodiment, for example, it is possible to further simplify the correlation data 160 compared with a form in which the feedback information is output based on a simple BCS value. As a result, for example, it is possible to further reduce a data capacity of the correlation data 160 and it is possible to further improve the ease of updating the correlation data 160.

In the present embodiment, the BCS evaluation value is acquired by a magnitude relationship between the BCS value and the reference value being compared. In this way, it is possible to acquire the BCS evaluation value by comparing the BCS value with the reference value with a simpler method.

### B. Second Embodiment:

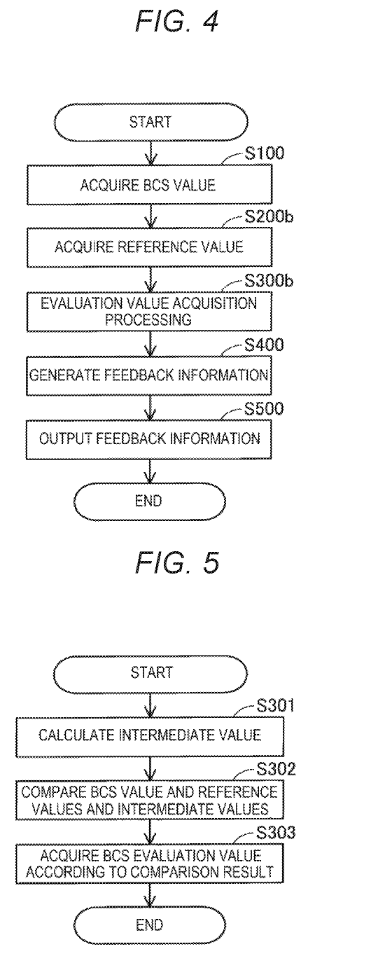

FIG. 4 is a flowchart of feedback processing in a second embodiment. In FIG. 4, the same steps as those in FIG. 3 are denoted by the same reference signs as those in FIG. 3. In the present embodiment, unlike the first embodiment, the reference value acquisition unit 112 acquires a plurality of reference values as reference values for evaluating a BCS value. Further, in the present embodiment, as explained below, content of processing executed in evaluation value acquisition processing is different from that in the first embodiment. Points not particularly explained of the breeding system 50, the feedback system 70, and the feedback device 100 in the present embodiment are the same as those in the first embodiment.

In step S200b in FIG. 4, the reference value acquisition unit 112 acquires a plurality of reference values. In the present embodiment, the reference values acquired in step S200b include a lower limit value, a standard value, and an upper limit value. In another embodiment, for example, the number of the plurality of reference values may be two or may be four or more.

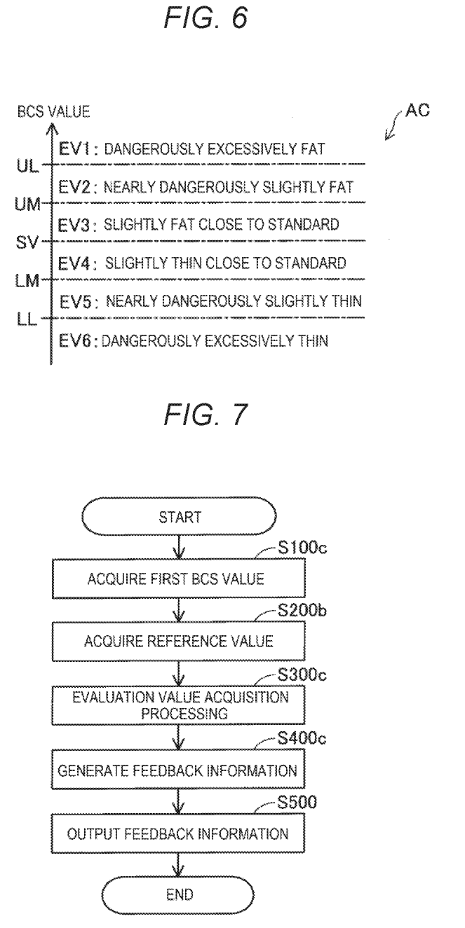

FIG. 5 is a flowchart of evaluation value acquisition processing executed in step S300b in FIG. 4. FIG. 6 is a diagram illustrating evaluation criteria AC for a BCS value in the second embodiment. In the present embodiment, in step S300b in FIG. 4, the BCS evaluation value acquisition unit 113 executes the evaluation value acquisition processing illustrated in FIG. 5.

In step S301 in FIG. 5, the BCS evaluation value acquisition unit 113 calculates an intermediate value for the reference values acquired in step S200b in FIG. 4. The intermediate value is calculated as a value that is larger than a smaller reference value of two numerically adjacent reference values and is smaller than a larger reference value of the two numerically adjacent reference values. For example, the intermediate value may be calculated as an average value of the two numerically adjacent reference values or may be calculated as a value smaller or larger than the average value. In the present embodiment, as illustrated in FIG. 6, an upper intermediate value UM, which is an intermediate value between an upper limit value UL and a standard value SV, and a lower intermediate value LM, which is an intermediate value between a lower limit value LL and the standard value SV, are calculated. The upper intermediate value UM and the lower intermediate value LM may include two or more different values.

In step S302 of FIG. 5, the BCS evaluation value acquisition unit 113 compares the acquired BCS value and the acquired reference values and the calculated intermediate values. In step S302, the BCS evaluation value acquisition unit 113 executes the comparison according to the evaluation criteria AC illustrated in FIG. 6. For example, when the BCS value acquired in step S100 of FIG. 4 is equal to or larger than the upper limit value UL, the BCS evaluation value acquisition unit 113 determines the BCS evaluation value as the evaluation value EV1 in step S302. For example, when the acquired BCS value is smaller than the upper intermediate value UM and equal to or larger than the standard value SV, the BCS evaluation value acquisition unit 113 determines the BCS evaluation value as the evaluation value EV2 in step S302. In step S303, the BCS evaluation value acquisition unit 113 acquires a BCS evaluation value according to a comparison result in step S302. That is, in step S303, the BCS evaluation value acquisition unit 113 acquires the BCS evaluation value determined in step S302. Thereafter, in step S400 in FIG. 4, feedback information is generated based on the BCS evaluation value acquired in step S303 of FIG. 5.

According to the second embodiment explained above, the BCS evaluation value is acquired by the magnitude relationships between the BCS value and the plurality of reference values being compared and the feedback information can be output based on the BCS evaluation value acquired in this way. For that reason, it is possible to acquire, with a simpler method, a BCS evaluation value obtained by more precisely evaluating the BCS value.

In the present embodiment, since the intermediate value is used in addition to the plurality of reference values in the evaluation of the BCS value, it is possible to acquire a BCS evaluation value obtained by still more precisely evaluating the BCS value. In the present embodiment, since the intermediate value is automatically calculated by the BCS evaluation value acquisition unit 113, it is possible to reduce a data capacity compared with, for example, a form in which a reference value equivalent to the intermediate value is stored in the storage unit 102 in advance. For example, compared with a form in which the user Ur is caused to input a reference value equivalent to the intermediate value, it is possible to reduce the time and effort for the user Ur to input the reference value. In another embodiment, the intermediate value may not be used for the output of the feedback information and, for example, the feedback information may be generated simply based on a plurality of reference values. In this case, the intermediate value may not be calculated.

### C. Third Embodiment:

FIG. 7 is a flowchart of feedback processing in a third embodiment. In FIG. 7, the same steps as those in FIGS. 3 and 5 are denoted by the same reference signs as those in FIGS. 3 and 5. In the present embodiment, unlike the first embodiment, the feedback unit 120 outputs feedback information based on the difference between a first BCS evaluation value obtained by evaluating a first BCS value and a second BCS evaluation value obtained by evaluating a second BCS value. Points not particularly explained of the breeding system 50, the feedback system 70, and the feedback device 100 in the present embodiment are the same as those in the second embodiment.

The first BCS value and the second BCS value are respectively BCS values for the same livestock. The first BCS value is a BCS value for the livestock in a first period. The second BCS value is a BCS value for the livestock in a second period. The second period is a period earlier than the first period. In the present embodiment, the second period is seven days before the first period. A reference value used to evaluate the first BCS value and a reference value used to evaluate the second BCS value may be the same or may be different from each other. In the present embodiment, as explained above, since the reference values corresponding to lactation periods are used, the reference value used to evaluate the first BCS value and the reference value used to evaluate the second BCS value can be different from each other. The first BCS evaluation value and the second BCS evaluation value explained above are also considered to be evaluation values respectively obtained by evaluating the livestock in different evaluation periods from the viewpoint of the BCS values. An "evaluation period" of a certain BCS evaluation value is also considered to represent when a BCS value for acquiring the BCS evaluation value was measured. For example, when evaluation of a BCS value is executed in real time, a period when a BCS evaluation value was acquired may be used as an evaluation period.

In step S100c in FIG. 7, the BCS evaluation value acquisition unit 113 acquires the first BCS value in the same manner as acquiring the BCS value in step S100 in FIG. 3. In step S300c in FIG. 7, the BCS evaluation value acquisition unit 113 acquires the first BCS evaluation value and the second BCS evaluation value. More specifically, in step S300c, the BCS evaluation value acquisition unit 113 acquires the first BCS evaluation value in the same manner as acquiring the BCS evaluation value in step S300b in FIG. 5. In step S300c, the BCS evaluation value acquisition unit 113 acquires the second BCS evaluation value corresponding to the first BCS evaluation value from the evaluation value history data 165 stored in the storage unit 102. More specifically, in the present embodiment, since the first BCS evaluation value is an evaluation value obtained by evaluating a current BCS value of the livestock and the second BCS evaluation value is an evaluation value obtained by evaluating a BCS value of seven days ago, the BCS evaluation value acquisition unit 113 acquires the second BCS evaluation value acquired in the evaluation of seven days ago.

In step S400c, the feedback unit 120 generates feedback information based on the first BCS evaluation value and the second BCS evaluation value acquired in step S300c.

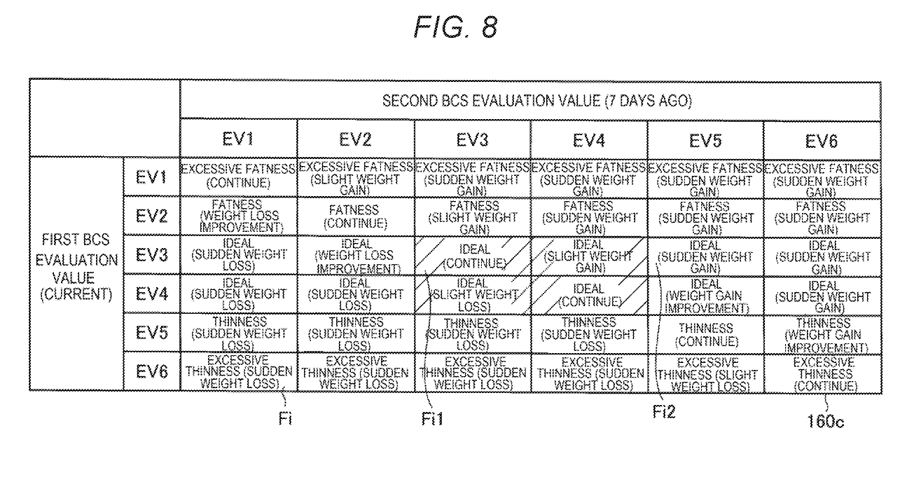

FIG. 8 is a diagram illustrating an example of correlation data 160c in the third embodiment. In step S400c in FIG. 7, the feedback unit 120 generates feedback information using the correlation data 160c illustrated in FIG. 8. The correlation data 160c is table data in which combinations of first BCS evaluation values and second BCS evaluation values and feedback information Fi are correlated.

As illustrated in FIG. 8, in the present embodiment, even if the first BCS evaluation values are respectively the same, if the second BCS evaluation values are respectively different, kinds of feedback information Fi that are respectively different can be output. For example, when both of the first BCS evaluation value and the second BCS evaluation value are the evaluation value EV3, feedback information Fi1 is output as the feedback information Fi. On the other hand, for example, when the first BCS evaluation value is also the evaluation value EV3 and the second BCS evaluation value is the evaluation value EV5, feedback information Fi2 is output as the feedback information Fi.

More specifically, in the present embodiment, feedback information reflecting a current situation including a current state and state transition due to elapse of time is output as the feedback information Fi. In FIG. 8, the current situation reflected on the feedback information Fi is represented in a form of a "current state (state transition)". The "current state" is determined according to the first BCS evaluation value. In the example illustrated in FIG. 8, when the first BCS evaluation value is the evaluation values EV1, EV2, EV3, EV4, EV5, and EV6, pieces of the feedback information Fi respectively reflect current states of excessively fat, fat, ideal, ideal, thin, and excessively thin. The "state transition" is determined according to the difference between the first BCS evaluation value and the second BCS evaluation value. For example, when the first BCS evaluation value is higher than the second BCS evaluation value, the state transition represents "weight gain" such as slight weight gain, sudden weight gain, and weight gain improvement. When the first BCS evaluation value is lower than the second BCS evaluation value, the state transition represents "weight loss" such as slight weight loss, sudden weight loss, and weight loss improvement. When the first BCS evaluation value and the second BCS evaluation value are the same, the state transition represents "continuation". In FIG. 8, the feedback information Fi reflecting the current situation of "good" is hatched. "Good" represents a combination of an "ideal state" serving as the current state and "continuation", "slight weight gain", or "slight weight loss" serving as the state transition.

Contents of the feedback information Fi1 and the feedback information Fi2 can be differentiated from each other by reflecting a condition that the current state is the same but the state transition is different between the feedback information Fi1 and the feedback information Fi2. For example, when information representing the current situation is output as the feedback information Fi, information representing that the ideal state is continued can be output as the feedback information Fi1 and information representing that the current ideal state has been reached because of sudden weight gain can be output as the feedback information Fi2. Further, for example, when information representing a feeding amount is output as the feedback information Fi, a feeding amount represented by the feedback information Fi2 can be set smaller than the feeding amount in the feedback information Fi1.

According to the third embodiment explained above, since the feedback information is output based on the difference between the first BCS evaluation value and the second BCS evaluation value, it is possible to reflect the transition of the BCS evaluation value due to elapse of time on the feedback information and it is possible to execute more appropriate livestock feedback FB.

In the present embodiment, since the feedback information is output based on the first BCS evaluation value and the second BCS evaluation value, the correlation data 160c tends to be more complicated compared with the correlation data 160 in the first embodiment and the second embodiment. However, in the present embodiment as well, as in the first embodiment and the second embodiment, since the feedback information is output based on the BCS evaluation value, it is possible to suppress such complication of the correlation data compared with, for example, a form in which feedback information is output based on two BCS values acquired in different periods.

### D. Fourth Embodiment:

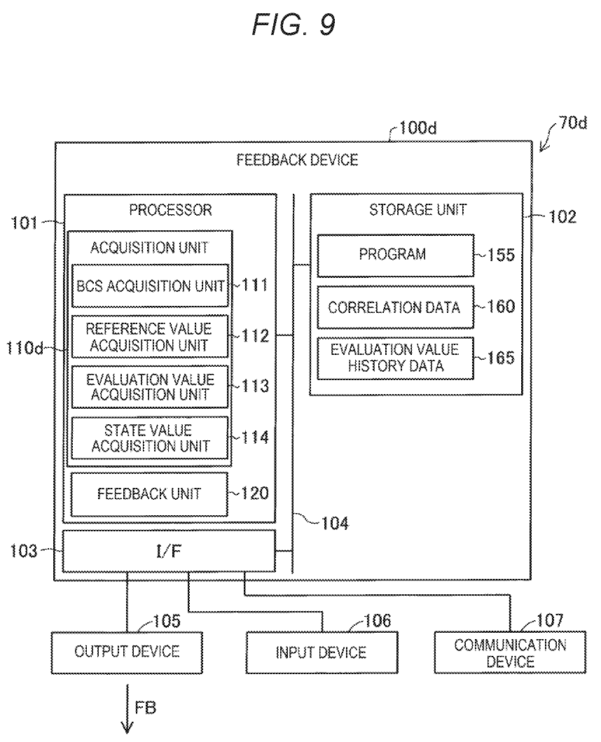

FIG. 9 is a block diagram illustrating a schematic configuration of a feedback system 70d in a fourth embodiment. In the present embodiment, unlike the first embodiment, an acquisition unit 110d further includes a state value acquisition unit 114 that acquires a state value. The feedback unit 120 outputs feedback information based on a BCS evaluation value and the state value. Points not particularly explained of the breeding system 50, the feedback system 70d, and the feedback device 100d in the present embodiment are the same as those in the first embodiment.

The state value is a value concerning a breeding state of livestock. The state value is a value different from the BCS value and represents information different from a BCS. For example, the state value may be a primary state value that is a state value serving as primary information representing a breeding state, or may be a secondary state value that is a state value serving as secondary information. The primary state value is, for example, a value serving as raw data acquired by the various sensors 200 or a value serving as raw data input via the input device 106. The secondary state value is a state value based on the primary state value and is, for example, a state correction value obtained by correcting the primary state value or a state evaluation value obtained by evaluating the primary state value. The secondary state value serving as the state evaluation value is acquired by comparing the magnitudes of the primary state value and a predetermined reference value in substantially the same manner as the BCS evaluation value.

The state value includes, for example, at least one of a milk amount value, a lactation period value, a body scale value, an age value, a number-of-times-of-birth value, a number-of-times of-insemination value, a feed intake amount value, a feeding amount value, a body temperature value, and a disease state value. The milk amount value is a value concerning a milk amount of livestock. The milk amount is represented by the weight and the volume of milk produced by the livestock per predetermined reference time. The reference time is, for example, one month, one week, one day, one minute, or one second. The milk amount may be represented by a standard milk amount. The standard milk amount is a milk amount obtained by converting a measured value of the milk amount into a milk amount measured under the same condition as a reference condition. The reference condition is a condition of "April to June delivery in Hokkaido, 120-th day after the second delivery". By using the standard milk amount as the milk amount, it is possible to evaluate the milk amount while suppressing differences due to a region, a season, the number of times of birth, and a lactation period. The lactation period value is a value concerning a lactation period of the livestock. The body scale value is a value concerning the body scale of the livestock. The body scale value includes, for example, a body height value concerning a body height of the livestock and a body width value concerning a body width of the livestock. The age value is a value concerning an age of the livestock. The number-of-times-of-birth value is a value concerning the number of times of birth of the livestock. The number of times of birth is also called "parity". The number-of-times of-insemination value is a value concerning the number of times of artificial insemination of the livestock. The feed intake amount value is a value concerning an intake amount of feed of the livestock. The feeding amount value is a value concerning an amount of feeding to the livestock. The body temperature value is a value concerning the body temperature of the livestock. The disease state value is a value concerning a disease state of the livestock. More specifically, the disease state value is, for example, a value concerning a type of a disease with which the livestock has been infected or a value concerning the number of times of infection of the livestock. For example, the number of times of infection may be measured for each type of a disease or may be measured as the number of times regardless of a type of a disease. For example, the state value acquisition unit 114 may acquire a state value using the sensor 200, may acquire a state value input by the user Ur via the input device 106, or may acquire a state value stored in the storage unit 102. For example, the milk amount, the feed intake amount value, and the feeding amount value may be acquired using a camera or a weight scale. The body scale may be acquired using, for example, a camera.

In the present embodiment, the state value acquisition unit 114 acquires the milk amount value as the state value. More specifically, the state value acquisition unit 114 acquires, as a state value serving as the basis of the feedback information, the milk amount value serving as the state evaluation value, that is, a milk amount evaluation value obtained by evaluating the milk amount. In the present embodiment, the state value acquisition unit 114 acquires the milk amount evaluation value by performing binary evaluation of the milk amount using a predetermined milk amount reference value. As a result, the state value acquisition unit 114 acquires, as the milk amount value, either a milk amount evaluation value MV1 representing that the milk amount value is equal to or larger than the milk amount reference value or a milk amount evaluation value MV2 representing that the milk amount value is smaller than the milk amount reference value.

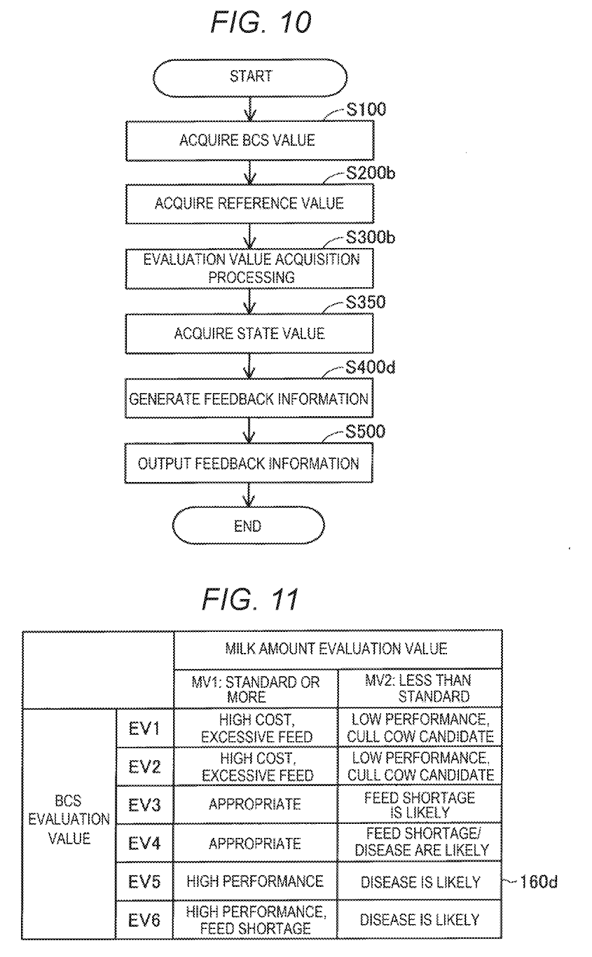

FIG. 10 is a flowchart of feedback processing in the fourth embodiment. In FIG. 10, the same steps as those in FIGS. 3 and 5 are denoted by the same reference signs as those in FIGS. 3 and 5. In step S350 of FIG. 10, the state value acquisition unit 114 acquires a state value. In step S400d, the feedback unit 120 generates feedback information based on the evaluation value acquired in step S300b and the state value acquired in step S350.

FIG. 11 is a diagram illustrating an example of correlation data 160d in the fourth embodiment. In step S400 in FIG. 10, the feedback unit 120 generates feedback information using the correlation data 160d illustrated in FIG. 11. The correlation data 160d is table data in which combinations of BCS evaluation values and milk amount evaluation values and feedback information are correlated.

As illustrated in FIG. 11, in the present embodiment, even if the BCS evaluation values are respectively the same, if state values are respectively different, different kinds of feedback information can be respectively output. In the example illustrated in FIG. 11, for example, when the BCS evaluation value is EV1 and the milk amount evaluation value is MV1, information representing "high cost, excessive feed" is output as the feedback information. On the other hand, when the BCS evaluation value is EV1 and the milk amount evaluation value is MV2, information representing "low performance, a cull cow candidate" is output as the feedback information. For example, when the BCS evaluation value is EV6 and the milk amount evaluation value is MV1, information representing "high performance, feed shortage" is output as the feedback information. On the other hand, when the BCS evaluation value is EV6 and the milk amount evaluation value is MV2, information representing "disease is likely" is output as the feedback information.

According to the fourth embodiment explained above, since the feedback information is output based on the BCS evaluation value and the state value, it is possible to reflect the state value on the feedback information in addition to the BCS evaluation value and it is possible to execute more appropriate livestock feedback FB. In particular, in the present embodiment, since the feedback information is output based on the BCS evaluation value and the milk amount value, for example, it is possible to output more appropriate feedback information that can improve the milk amount while taking into account the BCS evaluation value of the livestock.

In another embodiment, the number-of-times-of-birth value or the age value may be acquired as the state value. A milk amount of the cow BA, which is the livestock, tends to increase until the age of cow BA reaches a predetermined threshold and thereafter decrease. Substantially similarly, the milk amount of the cow BA, which is the livestock, tends to increase until the number of times of birth of the cow BA reaches a predetermined threshold and decrease when the number of times of birth exceeds the predetermined threshold. For that reason, for example, even if treatment for improving the milk amount is performed on the cow BA, the age or the number of times of birth of which exceeds a predetermined threshold, the milk amount tends to be less likely to be improved compared with when the same treatment is performed on the cow BA, the age or the number of times of birth of which is equal to or less than the predetermined threshold. As explained above, the number-of-times-of-birth value and the age value are useful indicators in determining a state of the livestock concerning the milk amount. Therefore, by using the number-of-times-of-birth value and the age value as the basis of the feedback information together with the BCS evaluation value, it is possible to increase the likelihood of more useful feedback information being output.

For example, in a form in which the number-of-times-of-birth value is acquired as the state value, when the BCS evaluation value is EV1 and the number-of-times-of-birth value is a value representing a relatively small number of times of birth, feedback information representing "high cost, excessive feed" can be output. On the other hand, in a form in which the number-of-times-of-birth value is acquired as the state value, when the BCS evaluation value is EV1 and the number-of-times-of-birth value is a value representing a relatively large number of times of birth, feedback information representing that "since the productivity is low, the cow needs to be culled" can be output. For example, in a form in which the age value is acquired as the state value, when the BCS evaluation value is EV1 and the age value is a value representing a relatively young age, feedback information representing "high cost, excessive feed" can be output. On the other hand, in the form in which the age value is acquired as the state value, when the BCS evaluation value is EV1 and the age value is a value representing a relatively old age, feedback information representing that "since the productivity is low, the cow needs to be culled" can be output. Even in these forms, it is possible to reflect the state value on the feedback information in addition to the BCS evaluation value and it is possible to execute more appropriate livestock feedback FB.

### E. Fifth Embodiment:

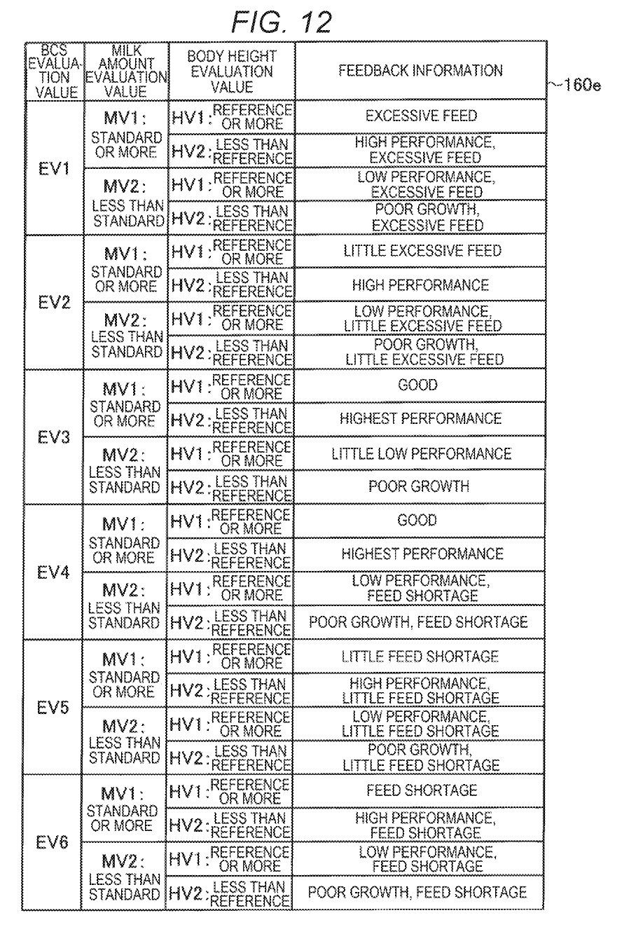

FIG. 12 is a diagram illustrating correlation data 160e according to a fifth embodiment. Unlike the correlation data 160d in the fourth embodiment, the correlation data 160e in the present embodiment is table data in which combinations of BCS evaluation values, milk amount evaluation values, and body scale evaluation values and feedback information are correlated. Points not particularly explained of the breeding system 50, the feedback system 70d, and the feedback device 100d in the present embodiment are the same as those in the fourth embodiment.

The body scale evaluation value is a body scale value serving as a state evaluation value, that is, an evaluation value obtained by evaluating a body scale. In the present embodiment, the state value acquisition unit 114 acquires the body scale evaluation value as a state value serving as the basis of the feedback information. More specifically, in the present embodiment, the body scale evaluation value is a body height evaluation value obtained by evaluating the body height of livestock. The state value acquisition unit 114 acquires the body height evaluation value by performing binary evaluation of the body height with a predetermined body height reference value. As a result, the state value acquisition unit 114 acquires, as the body scale value, one of a body height evaluation value HV1 representing that a body height value is equal to or larger than the body height reference value and a body height evaluation value HV2 representing that the body height value is smaller than the body height reference value. Hereinafter, a state value used as the basis of feedback information in addition to the milk amount value, such as the body scale evaluation value in the present embodiment, is also referred to as "third value".

In general, a body scale such as a body height is a useful indicator for determining whether livestock is small or large. In the cattle shed CB, a smaller livestock is more space-saving compared with a larger livestock. When milk amounts of livestock are the same between the smaller livestock and the larger livestock, the smaller livestock has higher performance from the viewpoint of effective use of a space. The body scale is a useful indicator for determining a growth state of the livestock. By using such a body scale value as the basis of the feedback information together with the BCS evaluation value, it is possible to increase the likelihood of more useful feedback information being output.

As illustrated in FIG. 12, in the present embodiment, different kinds of feedback information can be respectively output according to combinations of three values of the BCS evaluation value, the milk amount evaluation value, and the body scale evaluation value. In the example illustrated in FIG. 12, for example, when the BCS evaluation value is EV1, the milk amount evaluation value is MV1, and the body scale evaluation value is HV1, information representing "excessive feed" is output as the feedback information. On the other hand, when the BCS evaluation value and the milk amount evaluation value are respectively similarly EV1 and MV1 and the body scale evaluation value is HV2, information representing "high performance, excessive feed" is output as the feedback information.

According to the fifth embodiment explained above, as in the fourth embodiment, since the feedback information is output based on the BCS evaluation value and the state value, it is possible to execute more appropriate livestock feedback FB. In particular, in the present embodiment, since the feedback information is output based on the BCS evaluation value, the milk amount value, and the body scale value, it is possible to execute more appropriate livestock feedback FB.

In the example illustrated in FIG. 12, the body scale value is used as the third value. However, a state value other than the scale value may be used. For example, as the third value, a lactation period value, an age value, a number-of-times-of-birth value, a number-of-times-of-insemination value, a feed intake amount value, a feeding amount value, a body temperature value, or a disease state value may be used.

In addition to the milk amount value, two or more state values different from the milk amount value may be used as the basis of the feedback information.

### F. Sixth Embodiment:

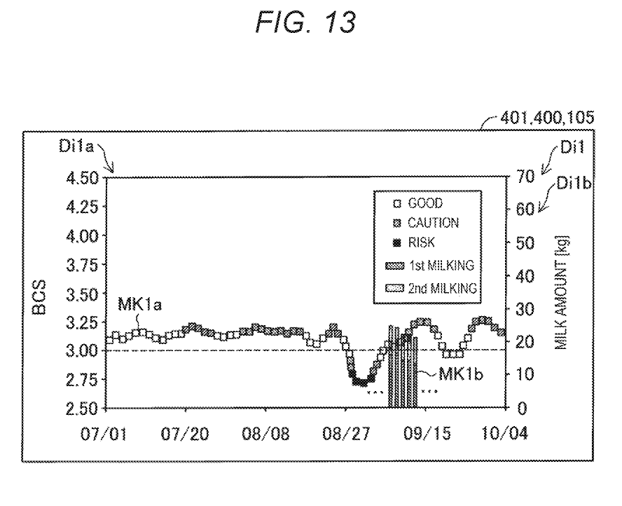

FIG. 13 is a diagram illustrating a first example of display information in a sixth embodiment. In the present embodiment, the feedback unit 120 outputs feedback information to a display device 400 serving as the output device 105 to display display information representing the feedback information on a display screen 401 of the display device 400 in a graph format such as a scattering diagram, a histogram, or a bar graph. FIG. 13 illustrates display information Di1 as an example of the display information explained above. The display device 400 is equivalent to a "display unit" in the present disclosure. Points not particularly explained of the breeding system 50, the feedback system 70, and the feedback device 100 in the present embodiment are the same as those in the fourth embodiment.

The display information Di1 is represented on the display screen 401 as a composite graph in which a scattering diagram Di1a representing a time-series change in a BCS value and a bar graph Di1b representing a time-series change in a milk amount are combined for one livestock individual. More specifically, the display information Di1 is represented as a composite graph in which the horizontal axis represents a date, the first vertical axis represents a BCS value, and the second vertical axis represents a milk amount. In the present embodiment, the BCS value in the display information Di1 is a temporal statistical value of BCS values. More specifically, the BCS value in the display information Di1 is a moving average value of BCS values acquired in seven days. The BCS value in the display information Di1 may be a moving average value of BCS values in a period of any length not limited to seven days. The length of the period may be, for example, optionally selectable by the user. In another embodiment, the BCS value in the display information Di1 may be a temporal statistical value different from the moving average value, may be raw data of the BCS value, or may be a correction value obtained by correcting the raw data of the BCS value.

In the scattering diagram Di1a, markers MK1a representing BCS values and evaluation values are arranged in chronological order. The markers MK1a represent the BCS values with display positions of the markers MK1a. More specifically, the markers MK1a represent the BCS values with vertical axis positions of the markers MK1a in the scattering diagram Di1a. The markers MK1a represent the BCS evaluation values with color degrees of the markers MK1a. The degrees of the colors are represented by at least any one of color, saturation, brightness, and shading. In FIG. 13, such differences in the degrees of the colors are expressed as differences in forms of hatching. In the example illustrated in FIG. 13, a green marker MK1a represents a BCS evaluation value of "good". The BCS evaluation value of "good" represents either the evaluation value EV3 or the evaluation value EV4. A yellow marker MK1a represents a BCS evaluation value of "caution". The BCS evaluation value of "caution" represents either the evaluation value EV2 or the evaluation value EV5. A red marker MK1a represents a BCS evaluation value of "danger". The BCS evaluation value of "danger" represents either the evaluation value EV1 or the evaluation value EV6. The user Ur can identify whether the marker MK1a represents a higher BCS evaluation value or a lower BCS evaluation value by checking a display position of the marker MK1a and a color of the marker MK1a.

In the bar graph Di1b, markers MK1b representing milk amounts are arranged in chronological order. The markers MK1b represent the numbers of times of milking with color degrees. In the example illustrated in FIG. 13, an orange marker MK1b represents a milk amount by first milking. An ocher marker MK1b represents a milk amount by second milking. In FIG. 13, for convenience of illustration, a part of the markers MK1b is omitted in time series.

By visually recognizing the display information Di1, for example the user Ur can compare an increase or decrease in a milk amount and an increase or decrease in a BCS value and examine an appropriate BCS value for increasing the milk amount. By checking transition of BCS values from the past to the present, the user Ur can evaluate whether livestock is a healthy livestock individual having a relatively small change in a body shape or a livestock individual having a relatively large change in a body shape and difficult to handle. In the display information Di1, a lactation period value such as the number of days after delivery may be used as the horizontal axis.

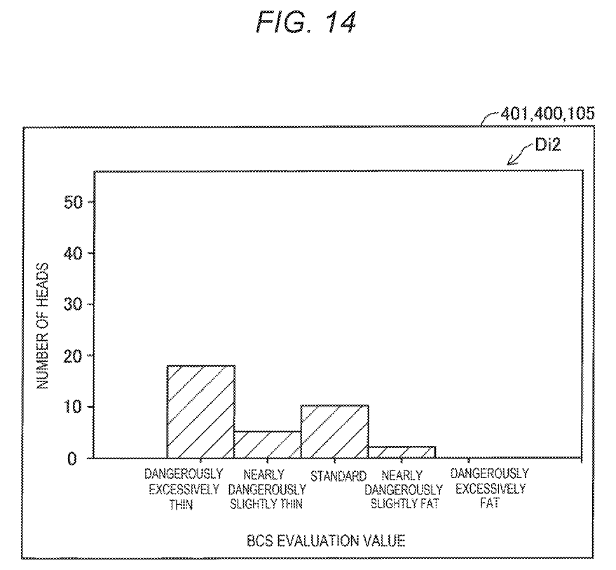

FIG. 14 is a diagram illustrating a second example of the display information in the sixth embodiment. FIG. 14 illustrates display information Di2 as an example of the display information. The display information Di2 is expressed on the display screen 401 as a histogram representing a frequency distribution of a plurality of livestock individuals corresponding to BCS evaluation values. More specifically, the display information Di2 is expressed as a histogram in which the horizontal axis represents a BCS evaluation value and the vertical axis represents the number of heads.

"dangerously excessively thin, "nearly dangerously slightly thin", "nearly dangerously slightly fat", and "dangerously excessively fat" in the display information Di2 are respectively equivalent to the evaluation values EV6, EV5, EV2, and EV1. The "standard" in the display information Di2 is equivalent to the evaluation values EV3 and EV4. In another embodiment, for example, the frequency distribution may be divided and displayed according to a lactation period.

The horizontal axis of the histogram in the display information Di2 is also considered to represent a degree of deviation from the standard. More specifically, in the histogram of the display information Di2, "standard" is displayed at the center. The evaluation values EV2 and EV1 are arranged in this order from the "standard" to the right. The evaluation values EV5 and EV6 are arranged in this order from the "standard" to the left.

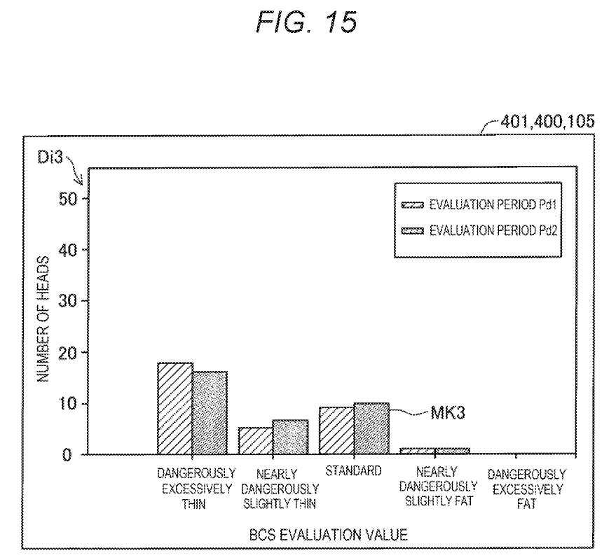

FIG. 15 is a diagram illustrating a third example of the display information in the sixth embodiment. FIG. 15 illustrates display information Di3 as an example of the display information. The display information Di3 is displayed as a histogram like the display information Di2. In the display information Di3, a marker MK3 equivalent to a bin representing a frequency distribution represents an evaluation period with a color degree. In the example illustrated in FIG. 15, a blue marker MK3 represents an evaluation period Pd1. An orange marker MK3 represents an evaluation period Pd2 later than the evaluation period Pd1. In FIG. 15, such a difference in the degree of the color is expressed as a difference in a form of hatching.

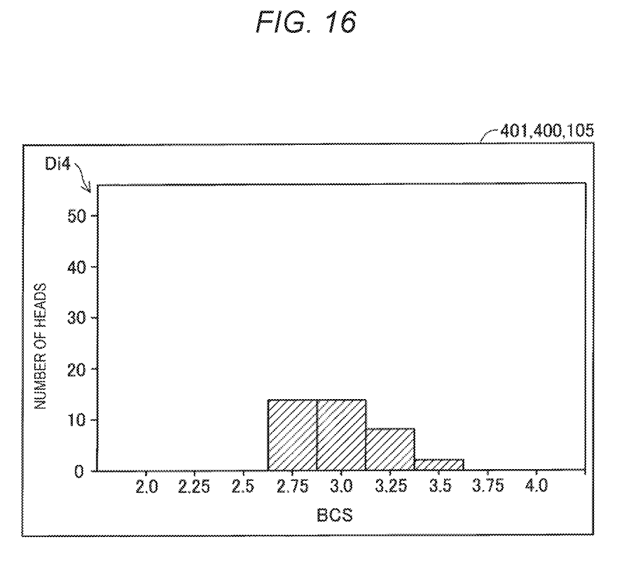

FIG. 16 is a diagram illustrating a fourth example of the display information in the sixth embodiment. FIG. 16 illustrates display information Di4 as an example of the display information. Unlike the display information Di1 to Di3, the display information Di4 is not the display information representing the feedback information based on the BCS evaluation value but is display information based on a BCS value. The display information Di4 is expressed as a histogram like the display information Di2 and the display information Di3. However, unlike the display information Di2 and the display information Di3, the histogram in the display information Di4 represents a frequency distribution of a plurality of livestock individuals according to the BCS value. The feedback device 100 may be configured to be capable of displaying other display information like the display information Di4 in addition to the display information representing the feedback information like the display information Di1 to Di3.

In the display information serving as the histograms illustrated in FIGS. 14 to 16, not only the BCS value but also any item may be used as an item on the horizontal axis. For example, as the item on the horizontal axis, an item representing the pieces of feedback information Fi in the correlation data 160c illustrated in FIG. 8 may be used or an item representing other feedback information such as a degree of increase in feed, a degree of decrease in feed, or a degree of recommendation for cow cull may be used. These degrees may be defined by, for example, a binary value equivalent to YES and NO.

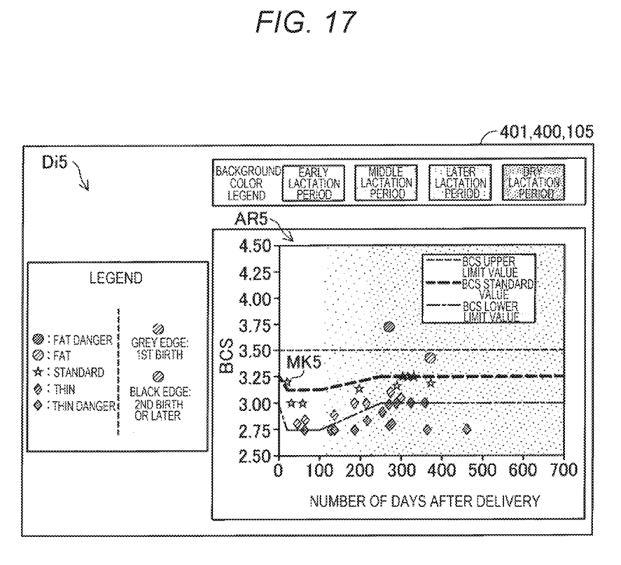

FIG. 17 is a diagram illustrating a fifth example of the display information in the sixth embodiment. FIG. 17 illustrates display information Di5 as an example of the display information. The display information Di5 is expressed as a scattering diagram representing a correspondence relationship between a BCS evaluation value and a state value for one or more livestock individuals on the display screen 401. More specifically, the display information Di5 is a scattering diagram in which the horizontal axis represents the number of days after delivery and the vertical axis represents a BCS value. The number of days after delivery is equivalent to an example of a lactation period value. The display information Di5 includes a marker MK5 representing the BCS evaluation value. The marker MK5 represents a BCS evaluation value for each livestock individual. In the display information Di5, markers MK5 are displayed to be arranged according to lactation period values. As explained above, the display information Di5 represents the correspondence relationship between the BCS evaluation value and the lactation period value.

"Fat danger", "fat", "thin", and "thin danger" for the marker MK5 in the display information Di5 are respectively equivalent to the evaluation values EV1, EV2, EV5, and EV6. "Standard" is equivalent to the evaluation values EV3 and EV4. The marker MK5 represents the BCS evaluation value with a combination of a shape and a color degree of the marker MK5. More specifically, a circular marker MK5 represents an evaluation value higher than the evaluation values EV3 and EV4 equivalent to the "standard". Colors in contours of the markers MK5 representing the evaluation values EV1 and EV2 are respectively red and yellow. A rhombic marker MK5 represents an evaluation value lower than the evaluation values EV3 and EV4 equivalent to the "standard". Colors in contours of the markers MK5 representing the evaluation values EV5 and EV6 are respectively yellow and red. That is, the colors in the contours of the markers MK5 change in the order of yellow and red as the markers MK5 further deviate from the standard value. In particular, marker MK5 representing the evaluation values EV1 and EV6 most deviating from the standard value are represented by red reminding "danger" or "warning". Accordingly, it is possible to cause to intuitively understand that a BCS evaluation value represented by the marker MK5 is at an alert level while drawing attention of the user Ur to the marker MK5. In FIG. 17, a difference in a color degree in a contour of the marker MK5 and a difference in a color degree of a display region AR5 explained below are expressed as a difference in a form of hatching.

The marker MK5 represents the number of times of birth with a color degree of the contour of the marker MK5. More specifically, the marker MK5 having a gray contour represents that the number of times of birth is once. The marker MK5 having a black contour represents that the number of times of birth is twice or more. In FIG. 17, the gray contour is schematically represented by a broken line.

In the display information Di5, the display region AR5 where the marker MK5 is displayed is configured such that a color degree of the display region AR5 is different according to a lactation period of the livestock. More specifically, in the display region AR5, background colors of a region representing an early lactation period, a region representing a middle lactation period, a region representing a later lactation period, and a region representing a dry lactation period are respectively represented by light blue, light blue purple, light red purple, and light brown.

An auxiliary line representing the BCS reference value is displayed on a scattering diagram in the display information Di5. In FIG. 17, as examples of the auxiliary line displayed in this manner, an auxiliary line representing a BCS upper limit value, an auxiliary line representing a BCS standard value, and an auxiliary line representing a BCS lower limit value are respectively indicated by a thin broken line, a thick broken line, and an alternate long and short dash line.

By visually recognizing the display information Di5, the user Ur can check the number of days after delivery and the BCS evaluation value of livestock individuals at a glance and can easily grasp the excess or deficiency of feed, the presence or absence of a disease risk, and the like.

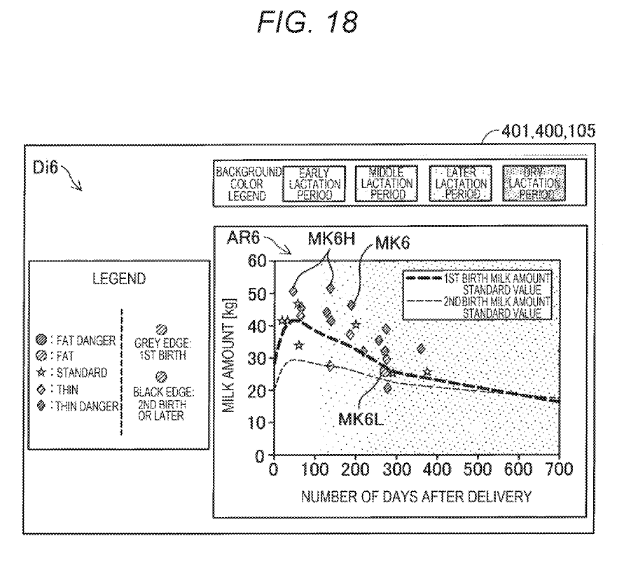

FIG. 18 is a diagram illustrating a sixth example of the display information in the sixth embodiment. FIG. 18 illustrates display information Di6 as an example of the display information. The display information Di6 is expressed as a scattering diagram representing a correspondence relationship between an evaluation value and a state value on the display screen 401. More specifically, the display information Di6 is a scattering diagram in which the horizontal axis represents the number of days after delivery and the vertical axis represents a milk amount. The marker MK6 in the display information Di6 is the same as the marker MK5. As in the display information Di5, in the display information Di6, a display region AR6 where the marker MK6 is displayed is configured such that a color degree of the display region AR6 is different according to a lactation cycle of the livestock. In FIG. 18, as in FIG. 17, a difference in a color degree in a contour of the marker MK6 and a difference in a color degree of the display region AR6 are expressed as differences in a form of hatching.

An auxiliary line representing a milk amount reference value is displayed on the scattering diagram in the display information Di6. In FIG. 18, as an example of the auxiliary line displayed in this way, an auxiliary line representing a milk amount reference value in first birth and an auxiliary line representing a milk amount reference value in second birth are respectively indicated by a thick broken line and a thin broken line. The first birth and the second birth referred to herein respectively represent that the number of times of birth is once and twice.

The display information Di6 is displayed on the display screen 401 such that livestock with high milk productivity is visualized. The "milk productivity" referred to herein is not limited to the magnitude of a production amount of milk and may be a level of performance concerning the production of milk. The performance concerning the production of milk represents, for example, a milk amount per unit cost of the livestock or a milk amount per unit occupied area of the livestock. Unit cost of a certain livestock may be evaluated based on, for example, expenses of feed given to the livestock, a feeding amount value for the livestock, or a feed intake amount value for the livestock. In the present embodiment, the "milk productivity" is equivalent to a level of a production amount of milk per unit cost of the livestock. More specifically, for example, a livestock individual represented by a marker MK6H in FIG. 18 is a livestock individual that is relatively thin and has a milk amount value relatively greatly exceeding the milk amount reference value. Therefore, the livestock individual represented by the marker MK6H has high probability of being a livestock individual having a relatively large milk amount with respect to spent cost and is a livestock individual having high milk productivity. The display information Di6 is displayed on the display screen 401 such that livestock with low milk productivity is visualized. More specifically, for example, a livestock individual represented by a marker MK6L is a livestock individual that is relatively fat and has a milk amount value smaller than the milk amount reference value. Therefore, the livestock individual represented by the marker MK6L has high probability of being a livestock individual having a relatively small milk amount with respect to spent cost and is a livestock individual having low milk productivity. In the display information Di5, the BCS evaluation value is represented by the marker MK6 and an auxiliary line indicating the milk amount reference value is displayed to visualize, on the display screen 401, livestock with high milk productivity and livestock with low milk productivity. In another embodiment, livestock with high milk productivity and livestock with low milk productivity may be visualized by, for example, a color degree, a size, and a shape of a marker.

The user Ur can simultaneously check the BCS evaluation value and the milk amount value by visually recognizing the display information Di6 and can easily evaluate milk productivity of the cow BA, which is the livestock. For example, the user Ur can easily grasp a livestock individual with low milk productivity using the display information Di6 and examine disposal of the livestock individual. For example, using the display information Di6, the user Ur can easily grasp a livestock individual that is excessively thin and has a milk amount less than the milk amount reference value and can easily grasp that the livestock individual is likely to be sick.

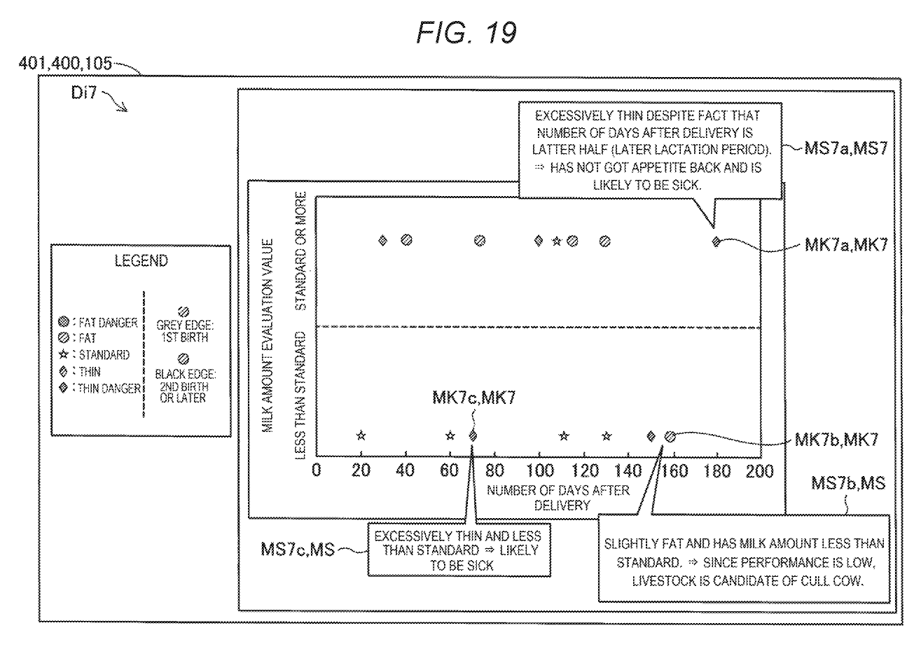

FIG. 19 is a diagram illustrating a seventh example of the display information in the sixth embodiment. FIG. 19 illustrates display information Di7 as an example of the display information. The display information Di7 is displayed on the display screen 401 as a graph representing a correspondence relationship between an evaluation value and a state value. More specifically, the display information Di7 is a scattering diagram in which the horizontal axis represents the number of days after delivery and the vertical axis represents a milk amount evaluation value. "Standard or more" and "less than standard" for the milk amount evaluation value in a graph of the display information Di7 are respectively equivalent to the milk amount evaluation value MV1 and the milk amount evaluation value MV2. In the graph of the display information Di7, an auxiliary line representing the milk amount reference value is displayed. In FIG. 19, the auxiliary line is indicated by a broken line.

The display information Di7 includes a marker MK7 and a message MS7. Like the marker MK5 and the marker MK6, the marker MK7 represents a BCS evaluation value for each livestock individual. The message MS7 is a message related to the livestock to the user Ur. The message MS7 is displayed on the display screen 401 by selection operation for selecting the marker MK7 being executed on the display screen 401. The selection operation may be, for example, operation of superimposing a selection cursor on the marker MK7 on the display screen 401 or may be click operation or tap operation. On the display screen 401, for example, the message MS7 may be displayed as a balloon near the marker MK7, may be displayed as a pop-up, or may be displayed in a predetermined message box arranged side by side with the graph in the display information Di7. In the display information Di7, for example, as in the display information Di5 and the display information Di6, a display region where the marker MK7 is displayed may be configured such that a color degree of the display region is different according to the lactation cycle of the livestock.

In the example illustrated in FIG. 19, for example, when a marker MK7a is selected, a message MS7a is displayed. The marker MK7a represents the evaluation value EV6, the milk amount evaluation value MV1, and the number of days after delivery of approximately 180 days with a shape, a color degree, and a display position of the marker MK7a. The message MS7a is "The livestock is excessively thin despite the fact that the number of days after delivery is the latter half (the later lactation period). The livestock has not got appetite back and is likely to be sick." reflecting the evaluation value EV6, the milk amount evaluation value MV1, and the number of days after delivery represented by the marker MK7a. In the example illustrated in FIG. 19, when a marker MK7b is selected, a message MS7b is displayed. The marker MK7b represents the evaluation value EV3, the milk amount evaluation value MV2, and the number of days after delivery of approximately 160 days with a shape, a color degree, and a display position of the marker MK7b. The message MS7b is "The livestock is slightly fat and has a milk amount less than a standard. Since performance is low, the livestock is a candidate of a cull cow." reflecting the evaluation value EV3, the milk amount evaluation value MV2, and the number of days after delivery represented by the marker MK7b. In the example illustrated in FIG. 19, when a marker MK7c is selected, a message MS7c is displayed. The marker MK7c represents the evaluation value EV6, the milk amount evaluation value MV2, and the number of days after delivery of approximately 70 days with a shape, a color degree, and a display position of the marker MK7c. The message MS7c is "The livestock is excessively thin and less than the standard and is likely to be sick" reflecting the evaluation value EV6, the milk amount evaluation value MV2, and the number of days after delivery represented by the marker MK7c.

Since the milk amount evaluation value is used as the milk amount value in the display information Di7, it is possible to more clearly visualize the productivity of milk as compared with, for example, when the milk amount itself is used as the milk amount value. For example, the user Ur can easily grasp, using the display information Di7, a livestock individual that is excessively fat and has a milk amount less than a reference value and examine disposal of the livestock individual. For example, the user Ur can easily grasp, using the display information Di7, a livestock individual that is excessively thin and has a milk amount less than the reference value and can easily confirm that the livestock individual is likely to be sick.

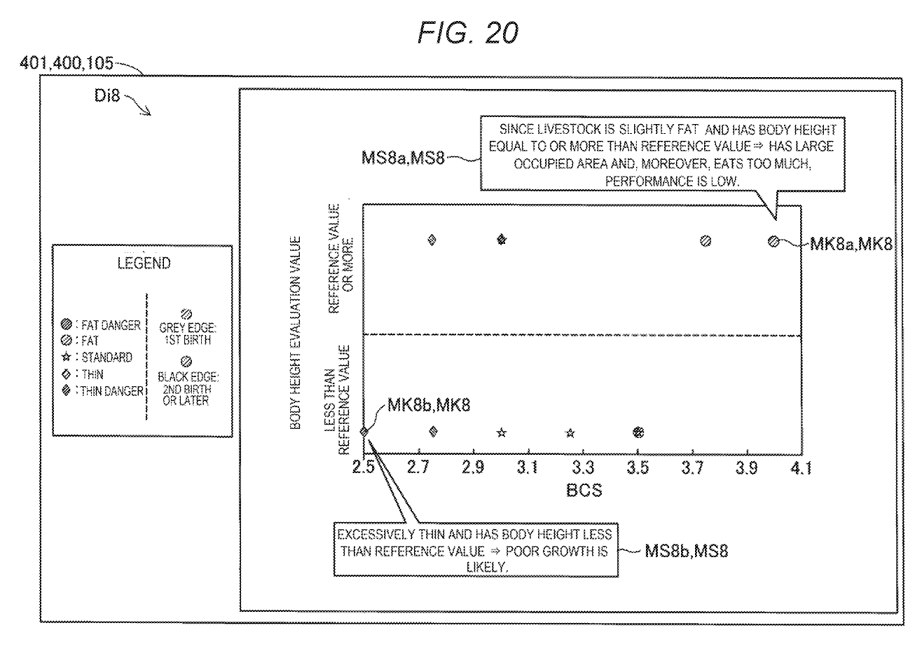

FIG. 20 is a diagram illustrating an eighth example of the display information in the sixth embodiment. FIG. 20 illustrates display information Di8 as an example of the display information. The display information Di8 is displayed on the display screen 401 as a graph representing a correspondence relationship between an evaluation value and a state value. More specifically, the display information Di8 is a scattering diagram in which the horizontal axis represents a BCS value and the vertical axis represents a body height evaluation value, which is an example of a body scale evaluation value. Like the display information Di7, the display information Di8 includes a marker MK8 and a message MS8. Like the marker MK5, the marker MK6, and the marker MK7, the marker MK8 represents a BCS evaluation value for each livestock individual. Like the message MS7, the message MS8 is a message concerning livestock to the user Ur and is displayed on the display screen 401 by selection operation for selecting the marker MK8 being executed on the display screen 401. "A reference value or more" and "less than the reference value" for the body height evaluation value in the graph of the display information Di8 are respectively equivalent to the body height evaluation value HV1 and the body height evaluation value HV2. In the graph in the display information Di8, an auxiliary line representing the body height reference value is displayed. In FIG. 20, the auxiliary line is indicated by a broken line.

In the example illustrated in FIG. 20, for example, when a marker MK8a is selected, a message MS8a is displayed. The marker MK8a represents the evaluation value EV3, the body height evaluation value HV1, and a BCS value of 4.0 with a shape, a color degree, and a display position of the marker MK8a. The message MS8a is "The livestock has low performance because the livestock is slightly fat, has a body height equal to or more than a reference value and a large occupied area, moreover, eats too much." reflecting the evaluation value EV3 and the body height evaluation value HV1 represented by the marker MK8a. In the example illustrated in FIG. 20, when a marker MK8b is selected, a message MS8b is displayed. The marker MK8b represents the evaluation value EV6, the body height evaluation value HV2, and a BCS value of 2.5 with a shape, a color degree, and a display position of the marker MK8b. The message MS8b is "It is likely the livestock is excessively thin and has a body height less than the reference value and poor growth is likely." reflecting the evaluation value EV6 and the body height evaluation value HV2 represented by the marker MK8b.

By visually recognizing the display information Di8, the user Ur can simultaneously check a BCS evaluation value and a body scale value and can easily grasp a relationship between a BCS value and a growth degree of the livestock individual and the performance of the livestock individual. For example, by using the display information Di8, the user Ur can easily grasp a livestock individual that has a relatively large body scale and is slightly fat and can grasp that the livestock individual is a low-performance livestock individual that has a large occupied area and tends to store unnecessary energy. Also, by using the display information Di8, the user Ur can easily grasp a livestock individual that has a relatively small body scale and is excessively thin and easily grasp that the livestock individual is likely to have poor growth or insufficient nutrition.

According to the sixth embodiment explained above, since the feedback information is output to the display device 400 serving as the display unit, the display information representing the feedback information is displayed on the display screen 401 of the display device 400. For that reason, the feedback information can be provided to the user Ur as visual display information. In particular, in the present embodiment, since the display information is displayed in a graph format such as a scattering diagram, a histogram, or a bar graph, the feedback information serving as the visual display information can be provided to the user Ur with better visibility.

In the present embodiment, as illustrated in FIGS. 13, 17, 18, and 19, feedback information representing a correspondence relationship between a BCS evaluation value and a state value including a milk amount value is displayed on the display screen 401 as display information. For that reason, the feedback information representing the correspondence relationship between the BCS evaluation value and the milk amount value can be provided to the user Ur as visual display information. As a result, the user Ur can effectively examine, using the provided feedback information, for example, a BCS value suitable for improving a milk amount.

In the present embodiment, as illustrated in FIG. 18, display information is displayed on the display screen 401 such that livestock with high milk productivity is visualized. For that reason, it is possible to effectively inform the livestock with high milk productivity to the user Ur.

In the present embodiment, as illustrated in FIG. 18, display information is displayed on the display screen 401 such that livestock with low milk productivity is visualized. For that reason, it is possible to effectively inform the livestock with low milk productivity to the user Ur.

In the present embodiment, as illustrated in FIGS. 18 and 19, feedback information representing a correspondence relationship between a BCS evaluation value and a state value including a milk amount value and a lactation period value is displayed on the display screen 401 as display information. According to this embodiment, the user Ur can examine, using the feedback information provided as the display information, according to the lactation period of the livestock, for example, whether to implement measures for improving a milk amount and a type of the measures to be implemented. In this embodiment, the state value may include at least any one of a body scale value and an age value, a number-of-times-of-birth value, a number-of-times-of-insemination value, a feed intake amount value, a feeding amount value, a body temperature value, and a disease state value instead of or in addition to the lactation period value. Even in this case, in the same manner as explained above, the user Ur can examine, according to a body height, an age, the number of times of birth, the number of times of insemination, a feed intake amount, a feeding amount, a body temperature, and a disease state of the livestock, for example, whether to implement measures for improving a milk amount and a type of the measures to be implemented.

In the present embodiment, the display information Di5 and Di6 illustrated in FIGS. 17 and 18 includes markers representing the BCS evaluation value. In the display information Di5 and Di6, the markers are displayed side by side according to a lactation period value. The display information Di5 and Di6 is displayed such that a color degree of a display region where the markers are displayed is different according to a lactation period of the livestock. Accordingly, it is possible to visually clearly display a relationship between the BCS evaluation value and the lactation period using the color degree of the display region. As a result, by using provided feedback information, the user Ur can appropriately manage a BCS of the livestock, for example, according to the lactation period.

In the present embodiment, the display information Di7 and Di8 illustrated in FIGS. 19 and 20 includes markers representing a BCS evaluation value and messages concerning the livestock to the user Ur. The messages in the display information Di7 and Di8 are displayed on the display screen 401 when the markers are selected on the display screen 401. Accordingly, it is possible to visually indicate the BCS evaluation value to the user Ur with the markers and effectively provide the messages when the user Ur desires. Further, by displaying the messages with balloon display or pop-up display, it is possible to more compactly display the display information on the display screen 401.

In the present embodiment, the display information Di1 illustrated in FIG. 13 includes markers displayed side by side in chronological order. The markers represent BCS values with display positions of the markers and represent BCS evaluation values with color degrees of the markers. For that reason, it is possible to display, with good visibility, temporal transition of BCS values and BCS evaluation values using the display positions and the color degrees of the markers.

In the present embodiment, the display information Di2 and Di3 illustrated in FIGS. 14 and 15 includes histograms representing frequency distributions of a plurality of livestock individuals corresponding to BCS evaluation values. For that reason, it is possible to cause, using the histograms, the user Ur to effectively grasp a tendency of the BCS evaluation values for the plurality of livestock individuals. The user Ur can easily learn a tendency of body shapes of livestock in the entire cattle shed CB using the histograms. As a result, for example, when there are relatively many livestock individuals that are a slightly overweight, the user Ur can examine implementation of treatments such as changing a type of food or reducing a feeding amount.

### G. Other Embodiments

(G-1) In the embodiments explained above, the breeding device 300 is not limited to the feeding machine 301 and the sensor 200 and may be any device used for breeding livestock. For example, instead of or in addition to the feeding machine 301 and the sensor 200, the breeding device 300 may include at least any one of a milking machine that milks cows, which are livestock, an air conditioner that air-conditions the cattle shed CB, an illuminator that illuminates the cattle shed CB, and a movement control device that controls the movement of livestock in the cattle shed CB. The air conditioner is configured as, for example, a device that cools the cattle shed CB, a device that heats the cattle shed CB, a device that humidifies the cattle shed CB, or a device that dehumidifies the cattle shed CB. The movement control device includes, for example, various doors such as a rotating door and an opening and closing door installed in the cattle shed CB and a stanchion capable of fixing the head of livestock.

(G-2) In the embodiments explained above, the feedback information may be output to the breeding device 300. Accordingly, it is possible to cause the breeding device 300 to operate according to the feedback information.

The feedback information for the breeding device 300 may be, for example, a control signal for controlling the breeding device 300. For example, when the BCS evaluation value is the evaluation value EV5 or the evaluation value EV6, the feedback unit 120 may output a control signal for increasing a feeding amount to the feeding machine 301 serving as the breeding device 300.

When the BCS evaluation value is the evaluation value EV5 or the evaluation value EV6, the feedback unit 120 may output a control signal for reducing a milking amount to the milking machine serving as the breeding device 300. The control signal for reducing the milking amount is, for example, a control signal for reducing the milking intensity of the milking machine or a control signal for reducing the milking frequency of the milking machine. Accordingly, for example, when a factor of weight loss of livestock is a disease such as mastitis, it is possible to prevent the disease of the livestock from worsening because of milking.

For example, when a BCS evaluation value of a certain livestock is the evaluation value EV5 or the evaluation value EV6 in a period when the temperature is relatively high, such as summer, the feedback unit 120 may output a control signal for improving a degree of cooling for the livestock to the air conditioner serving as the breeding device 300. The control signal for improving the degree of cooling for the livestock is, for example, a control signal for lowering a set temperature of the cooling or a control signal for adjusting a wind direction of the air conditioner such that cool air is sent more frequently or stronger cool air is sent toward the livestock. Accordingly, for example, when a cause of the weight loss of the livestock is summer fatigue, it is possible to reduce the weight loss of the livestock.

For example, when a BCS evaluation value of a certain livestock is the evaluation value EV5 or the evaluation value EV6, the feedback unit 120 may output a control signal for reducing a stimulus by illumination to the illuminator serving as the breeding device 300. The control signal for reducing the stimulus by the illumination is, for example, a control signal for reducing a light amount of the illumination or a control signal for reducing a frequency of the illumination. Accordingly, for example, when a cause of weight loss of the livestock is stress due to stimulation, it is possible to reduce the weight loss of the livestock.

For example, when a BCS evaluation value of a certain livestock is the evaluation value EV1 or the evaluation value EV2, the feedback unit 120 may output a control signal for guiding the livestock to an eating restriction area for restricting eating of feed by the livestock or a control signal for keeping the livestock in the eating restriction area to the movement control device serving as the breeding device 300. Accordingly, for example, when a cause of excessive fatness of the livestock is excessive eating, it is possible to reduce the excessive fatness of the livestock. For example, when a BCS evaluation value of a certain livestock is the evaluation value EV5 or the evaluation value EV6, the feedback unit 120 may output a control signal for guiding the livestock to an eating promotion area for promoting eating of feed by the livestock or a control signal for keeping the livestock in the eating promotion area to the movement control device serving as the breeding device 300. Accordingly, for example, when a cause of weight loss of the livestock is an insufficient eating amount, it is possible to reduce the weight loss of the livestock.

Not only the control signal but also various information based on a BCS evaluation value may be output to the breeding device 300 as feedback information. For example, a BCS evaluation value may be output as feedback information to the sensor 200 serving as the breeding device 300, and the sensor 200 may execute an analysis using primary information acquired by itself and feedback information output from the feedback device 100 and transmit secondary information corresponding to an analysis result to the feedback device 100 as a detection result. For example, when the sensor 200 is an estrus detection sensor that detects estrus of the livestock, the sensor 200 may detect estrus of the livestock by executing an analysis using acceleration and angular velocity of the livestock serving as primary information acquired by the sensor 200 itself and feedback information and transmit information representing the estrus to the feedback device 100 as a detection result.

(G-3) The feedback unit 120 may cause the display screen 401 to display the feedback information serving as the display information in another format without being limited to the graph format. For example, the feedback unit 120 may cause the display screen 401 to display the display information serving as the feedback information in a list format. In this case, the display information may be, for example, a list in which information based on BCS evaluation values is vertically arranged for each piece of identification information of livestock individuals. In this case, in the list, in addition to the identification information and the BCS evaluation values of the livestock individuals, any information concerning the livestock individuals such as state values such as age values and lactation period values of the livestock individuals may be displayed side by side with the identification information and the BCS evaluation values. The identification information referred to herein is, for example, names of the livestock individuals or identification numbers of the livestock individuals. In this case, in the list, the feedback unit 120 may display a livestock individual having higher importance at a higher position, display a livestock individual having lower importance at a lower position, or omit display of a livestock individual having lower importance. The "livestock individual having higher importance" is, for example, a livestock individual having a BCS evaluation value obtained by evaluating a BCS value further deviating from a standard value, such as the evaluation value EV1 or EV6. Conversely, the "livestock individual having lower importance" is a livestock individual having a BCS evaluation value obtained by evaluating a BCS value closer to the standard, such as the evaluation value EV3, EV4, or EV0. In the list, the feedback unit 120 may cause the display screen 401 to display information concerning a livestock individual having higher importance and information concerning a livestock individual having lower importance in a mode different from a mode of information concerning other livestock individuals. Further, "display in a different mode" means, for example, differentiating a color degree of characters representing information, differentiating a size, thickness, and an angle of characters, or differentiating a degree of background color of information.

(G-4) In the embodiments explained above, the feedback unit 120 outputs the feedback information by referring to the correlation data 160 but is not limited thereto. For example, the feedback unit 120 may output the feedback information by inputting the BCS evaluation value to a feedback model. The feedback model is a machine learning model trained to output feedback information using the BCS evaluation value as input. As the feedback model, for example, a machine learning model similar to the estimation model can be used.

(G-5) In the embodiments explained above, the acquisition unit 110 acquires the BCS evaluation value by comparing the magnitude relationship between the BCS value and the reference value but is not limited thereto. For example, the acquisition unit 110 may acquire the BCS evaluation value by inputting the BCS value and the reference value to an evaluation model. The evaluation model is a machine learning model trained to receive the BCS value and the reference value as input and output the BCS evaluation value. As the evaluation model, for example, a machine learning model similar to the estimation model can be used.

(G-6) In the embodiments explained above, the feedback device 100 may include at least an acquisition unit that acquires a BCS evaluation value and the feedback unit 120. For that reason, the feedback device 100 may not include the BCS acquisition unit 111 and the reference value acquisition unit 112. The BCS acquisition unit 111 and the reference value acquisition unit 112 may be provided in a device on the outside of the feedback device 100 in the feedback system 70.

(G-7) In the embodiments explained above, the feedback unit 120 may output the feedback information serving as the display information not only to the display device 400 serving as the output device 105 but also to a display unit of an external device located on the outside of the feedback device 100. That is, the "display unit" in the present disclosure may be provided on the outside of the feedback device 100. In this case, the external device may be, for example, any terminal device such as a smartphone, a tablet terminal, or a computer used by the user. The external device explained above is connected to the feedback device 100 by, for example, wireless connection or wired connection. In this case, the feedback unit 120 outputs the feedback information to the external device using, for example, the communication device 107.

### H. Other Aspects:

The present disclosure is not limited to the embodiments explained above and can be implemented in various aspects without departing from the gist of the present disclosure. For example, the present disclosure can also be implemented by the following aspects. In order to solve a part or all of the problems of the present disclosure or in order to achieve a part or all of the effects of the present disclosure, the technical features in the embodiments explained above corresponding to technical features in the aspects explained below can be replaced or combined as appropriate. Unless the technical features are explained as essential technical features in the present specification, the technical features can be deleted as appropriate.

(1) According to a first aspect of the present disclosure, a feedback device is provided. The feedback device includes: an acquisition unit configured to acquire a BCS evaluation value obtained by evaluating a BCS value representing a body condition score of livestock with a reference value for evaluating the BCS value; and a feedback unit configured to output feedback information concerning the livestock based on the acquired BCS evaluation value.

According to this aspect, since the feedback information is output based on the BCS evaluation value obtained by evaluating the BCS value, it is possible to execute appropriate feedback concerning the livestock by utilizing a BCS of the livestock.

(2) In the above aspect, the feedback device may further include a storage unit configured to store correlation data in which the BCS evaluation value and the feedback information are correlated in advance, and the feedback unit may output the feedback information by referring to the correlation data based on the acquired BCS evaluation value. According to this aspect, it is possible to execute feedback with a simpler method.

(3) In the above aspect, the acquisition unit may acquire the BCS evaluation value by comparing a magnitude relationship between the BCS value and the reference value. According to this aspect, it is possible to acquire the BCS evaluation value by comparing the BCS value with the reference value with a simpler method.

(4) In the above aspect, the reference value may include a plurality of reference values, and the acquisition unit may acquire the BCS evaluation value by comparing a magnitude relationship between the BCS value and the plurality of reference values. According to this aspect, it is possible to output the feedback information based on a BCS evaluation value obtained by evaluating the BCS value with the plurality of reference values.

(5) In the above aspect, the BCS value may include a first BCS value for the livestock in a first period and a second BCS value for the livestock in a second period earlier than the first period, the BCS evaluation value may include a first BCS evaluation value for the first BCS value and a second BCS evaluation value for the second BCS value, and the feedback unit may output the feedback information based on the acquired first BCS evaluation value and the acquired second BCS evaluation value. According to this aspect, it is possible to reflect temporal transition of the BCS evaluation value on the feedback information and it is possible to execute more appropriate feedback.

(6) In the above aspect, the acquisition unit may further acquire a state value different from the BCS value, the state value concerning a breeding state of the livestock, and the feedback unit may output the feedback information based on the acquired BCS evaluation value and the acquired state value. According to this aspect, it is possible to reflect the state value on the feedback information in addition to the BCS evaluation value and it is possible to execute more appropriate feedback.

(7) In the above aspect, the feedback unit may output the feedback information to a display unit to cause a display screen of the display unit to display display information representing the feedback information. According to this aspect, it is possible to provide the feedback information to a user as visual display information.

(8) In the above aspect, the acquisition unit may further acquire a state value different from the BCS value, the state value concerning a breeding state of the livestock, the state value may include a milk amount value concerning a milk amount of a cow, which is the livestock, the feedback unit may output the feedback information based on the acquired BCS evaluation value and the acquired state value, and the feedback information may be information representing a correspondence relationship between the BCS evaluation value and the state value. According to this aspect, it is possible to provide the feedback information representing the correspondence relationship between the BCS evaluation value and the milk amount value to the user as visual display information. As a result, for example, the user can effectively examine a BCS value suitable for improving the milk amount by using the provided feedback information.

(9) In the above aspect, the feedback unit may cause the display screen to display the display information such that the livestock with high milk productivity is visualized. According to this aspect, it is possible to effectively inform the livestock with high milk productivity to the user.

(10) In the above aspect, the feedback unit may cause the display screen to display the display information such that the livestock with low milk productivity is visualized. According to this aspect, it is possible to effectively inform the livestock with low milk productivity to the user.

(11) In the above aspect, the state value may further include at least any one of a lactation period value concerning a lactation period of the livestock, a body scale value concerning a body scale of the livestock, an age value concerning an age of the livestock, a number-of-times-of-birth value concerning a number of times of birth of the livestock, a number-of-times-of-insemination value concerning a number of times of artificial insemination of the livestock, a feed intake amount value concerning an intake amount of feed of the livestock, a feeding amount value concerning a feeding amount to the livestock, a body temperature value concerning a body temperature of the livestock, and a disease state value concerning a disease state of the livestock. According to this aspect, the user can, using the feedback information provided as the display information, according to the lactation period, the body scale, the age, the number of times of birth, the number of times of insemination, the intake amount of feed, the feeding amount, the body temperature, and the disease state of the livestock, examine, for example, whether to implement measures for improving a milk amount and a type of the measures to be implemented.

(12) In the above aspect, the acquisition unit may further acquire a state value different from the BCS value, the state value concerning a breeding state of the livestock, the state value may include a lactation period value concerning a lactation period of the livestock, the feedback unit may output the feedback information based on the acquired BCS evaluation value and the acquired state value, the display information may include markers representing the BCS evaluation value, the markers being displayed side by side according to the lactation period value, and the feedback unit may cause the display screen to display the display information such that a color degree of a display region where the markers are displayed on the display screen is different according to the lactation period. According to this aspect, it is possible to visually clearly display a relationship between the BCS evaluation value and the lactation period using the color degree of the display region. As a result, the user can appropriately manage a BCS of the livestock according to, for example, the lactation period using the provided feedback information.

(13) In the above aspect, the display information may include a marker representing the BCS evaluation value and a message concerning the livestock to a user, the message being displayed on the display screen when the marker is selected on the display screen. According to this aspect, it is possible to visually indicate the BCS evaluation value to the user with the marker and effectively provide the message when the user desires.

(14) In the above aspect, the acquisition unit may further acquire the BCS value, the feedback unit may output the feedback information to the display unit based on the acquired BCS evaluation value and the acquired BCS value to cause the display screen to display the display information, the display information may include markers representing the BCS value and the BCS evaluation value, the markers being displayed side by side in chronological order, and the markers may represent the BCS value with display positions of the markers and represent the BCS evaluation value with color degrees of the markers. According to this aspect, it is possible to display temporal transition of the BCS value and the BCS evaluation value with good visibility using the display positions and the color degrees of the markers.

(15) In the above aspect, the livestock may include a plurality of livestock individuals, the acquisition unit may acquire a plurality of the BCS evaluation values by acquiring the BCS evaluation value for the plurality of livestock individuals, the feedback unit may output the feedback information to the display unit based on the acquired plurality of BCS evaluation values to cause the display screen to display the display information, and the display information may include a histogram representing a frequency distribution of the plurality of livestock individuals corresponding to the BCS evaluation values. According to this aspect, it is possible to, using the histogram, cause the user to effectively grasp a tendency of the BCS evaluation value for the plurality of livestock individuals.

(16) In the above aspect, the feedback unit may output the feedback information to a breeding device used for breeding the livestock, and the breeding device may include at least any one of a feeding machine that feeds the livestock, a milking machine that milks the livestock, an air conditioner that air-conditions a cattle shed of the livestock, a sensor for monitoring the livestock, an illuminator that illuminates the cattle shed, and a movement control device that controls movement of the livestock. According to this aspect, it is possible to, by outputting the feedback information to various breeding devices, cause the breeding devices to operate according to the feedback information.

(17) According to a second aspect of the present disclosure, a feedback system is provided. The feedback system includes: a BCS acquisition unit configured to acquire a BCS value representing a body condition score of livestock; a reference value acquisition unit configured to acquire a reference value for evaluating the BCS value; an evaluation value acquisition unit configured to acquire a BCS evaluation value obtained by evaluating the BCS value with the reference value; and a feedback unit configured to output feedback information concerning the livestock based on the acquired BCS evaluation value.

(18) According to a third aspect of the present disclosure, a feedback method is provided. The feedback method includes: acquiring a BCS evaluation value obtained by evaluating a BCS value representing a body condition score of livestock with a reference value for evaluating the BCS value; and outputting feedback information concerning the livestock based on the acquired BCS evaluation value.

(19) According to a fourth aspect of the present disclosure, a non-transitory computer-readable storage medium storing a program is provided. The program causes a computer to implement: a function of acquiring a BCS evaluation value obtained by evaluating a BCS value representing a body condition score of livestock with a reference value for evaluating the BCS value; and a function of outputting feedback information concerning the livestock based on the acquired BCS evaluation value.

The present disclosure can be implemented in forms of, for example, a non-transitory recording medium recording a program, a program product, and the like besides the aspects explained above. The program product may be provided as, for example, a recording medium recording a program or may be provided as a program product that can be distributed via a network.

What is claimed is:

1. A feedback device comprising:
an acquisition unit configured to acquire a BCS evaluation value indicating evaluation of a BCS value representing a body condition score of livestock; and
a feedback unit configured to output feedback information concerning the livestock based on the acquired BCS evaluation value.

2. The feedback device according to claim 1, further comprising a storage unit configured to store correlation data in which the BCS evaluation value and the feedback information are correlated in advance, wherein
the feedback unit outputs the feedback information by referring to the correlation data based on the acquired BCS evaluation value.

3. The feedback device according to claim 1, wherein the acquisition unit acquires the BCS evaluation value by comparing a magnitude relationship between the BCS value and a reference value for evaluating the BCS value.

4. The feedback device according to claim 3, wherein
the reference value includes a plurality of reference values, and
the acquisition unit acquires the BCS evaluation value by comparing a magnitude relationship between the BCS value and the plurality of reference values.

5. The feedback device according to claim 1, wherein
the BCS value includes a first BCS value for the livestock in a first period and a second BCS value for the livestock in a second period earlier than the first period,
the BCS evaluation value includes a first BCS evaluation value for the first BCS value and a second BCS evaluation value for the second BCS value, and
the feedback unit outputs the feedback information based on the acquired first BCS evaluation value and the acquired second BCS evaluation value.

6. The feedback device according to claim 1, wherein
the acquisition unit further acquires a state value different from the BCS value, the state value concerning a breeding state of the livestock, and
the feedback unit outputs the feedback information based on the acquired BCS evaluation value and the acquired state value.

7. The feedback device according to claim 1, wherein the feedback unit outputs the feedback information to a display unit to cause a display screen of the display unit to display display information representing the feedback information.

8. The feedback device according to claim 7, wherein
the acquisition unit further acquires a state value different from the BCS value, the state value concerning a breeding state of the livestock,
the state value includes a milk amount value concerning a milk amount of a cow, which is the livestock,
the feedback unit outputs the feedback information based on the acquired BCS evaluation value and the acquired state value, and
the feedback information is information representing a correspondence relationship between the BCS evaluation value and the state value.

9. The feedback device according to claim 8, wherein the feedback unit causes the display screen to display the display information such that the livestock with high milk productivity is visualized.

10. The feedback device according to claim 8, wherein the feedback unit causes the display screen to display the display information such that the livestock with low milk productivity is visualized.

11. The feedback device according to claim 8, wherein the state value further includes at least any one of a lactation period value concerning a lactation period of the livestock, a body scale value concerning a body scale of the livestock, an age value concerning an age of the livestock, a number-of-times-of-birth value concerning a number of times of birth of the livestock, a number-of-times-of-insemination value concerning a number of times of artificial insemination of the livestock, a feed intake amount value concerning an intake amount of feed of the livestock, a feeding amount value concerning a feeding amount to the livestock, a body temperature value concerning a body temperature of the livestock, and a disease state value concerning a disease state of the livestock.

12. The feedback device according to claim 7, wherein
the acquisition unit further acquires a state value different from the BCS value, the state value concerning a breeding state of the livestock,
the state value includes a lactation period value concerning a lactation period of the livestock,
the feedback unit outputs the feedback information based on the acquired BCS evaluation value and the acquired state value,
the display information includes markers representing the BCS evaluation value, the markers being displayed side by side according to the lactation period value, and
the feedback unit causes the display screen to display the display information such that a color degree of a display region where the markers are displayed on the display screen is different according to the lactation period.

13. The feedback device according to claim 7, wherein the display information includes a marker representing the BCS evaluation value and a message concerning the livestock to a user, the message being displayed on the display screen when the marker is selected on the display screen.

14. The feedback device according to claim 7, wherein
the acquisition unit further acquires the BCS value,
the feedback unit outputs the feedback information to the display unit based on the acquired BCS evaluation value and the acquired BCS value to cause the display screen to display the display information,
the display information includes markers representing the BCS value and the BCS evaluation value, the markers being displayed side by side in chronological order, and
the markers represent the BCS value with display positions of the markers and represent the BCS evaluation value with color degrees of the markers.

15. The feedback device according to claim 7, wherein
the livestock includes a plurality of livestock individuals,
the acquisition unit acquires a plurality of the BCS evaluation values by acquiring the BCS evaluation value for the plurality of livestock individuals,
the feedback unit outputs the feedback information to the display unit based on the acquired plurality of BCS evaluation values to cause the display screen to display the display information, and
the display information includes a histogram representing a frequency distribution of the plurality of livestock individuals corresponding to the BCS evaluation values.

16. The feedback device according to claim 1, wherein
the feedback unit outputs the feedback information to a breeding device used for breeding the livestock, and
the breeding device includes at least any one of a feeding machine that feeds the livestock, a milking machine that milks the livestock, an air conditioner that air-conditions a cattle shed of the livestock, a sensor for monitoring the livestock, an illuminator that illuminates the cattle shed, and a movement control device that controls movement of the livestock.

17. A feedback system comprising:
a BCS acquisition unit configured to acquire a BCS value representing a body condition score of livestock;
a reference value acquisition unit configured to acquire a reference value for evaluating the BCS value;
an evaluation value acquisition unit configured to acquire a BCS evaluation value obtained by evaluating the BCS value with the reference value; and
a feedback unit configured to output feedback information concerning the livestock based on the acquired BCS evaluation value.

18. A feedback method comprising:
acquiring a BCS evaluation value indicating evaluation of a BCS value representing a body condition score of livestock; and
outputting feedback information concerning the livestock based on the acquired BCS evaluation value.
